(19) United States
(12) Patent Application Publication
(10) Pub. No.: US 2019/0163876 A1
(43) Pub. Date: May 30, 2019

(54) Kiosk Dispenser Interactive Original Order Entry Software Application

(71) Applicants: Randall Nelson Remme, Blue Mountains (CA); Kevin Cyril Anstey, Oakville (CA); Peter Matthew Tyson, North York (CA)

(72) Inventors: Randall Nelson Remme, Blue Mountains (CA); Kevin Cyril Anstey, Oakville (CA); Peter Matthew Tyson, North York (CA)

(73) Assignee: MedAvail, Inc., San Francisco, CA (US)

(21) Appl. No.: 14/830,353

(22) Filed: Aug. 19, 2015

Related U.S. Application Data
(60) Provisional application No. 62/039,687, filed on Aug. 20, 2014.

(51) Int. Cl. G06F 19/00; G06Q 30/06; G06Q 50/22; B65C 9/00; B65C 9/26

(52) U.S. Cl. CPC G06F 19/3462; G06Q 30/0635; B65C 2009/0018; B65C 9/0015; B65C 9/26; G06Q 50/22

(57) ABSTRACT

A control center receives an order from a patient's smart phone to fill a new prescription prescribed by a doctor to a patient, along with a selection of one drug dispensing kiosk. A remotely located pharmacist video teleconferences with the patient via the patient's smart phone to provide counseling about the prescribed pharmaceutical. The patient goes to the drug dispensing kiosk where the patient inputs information that is communicated to the control center. In response to the patient's input, the remotely located pharmacist initiates a transmission to the control center. In response to receiving input from the remotely located pharmacist, the control center communicates an order to dispense the new prescription to the patient from the drug dispensing kiosk such that the order to dispense the new prescription to the patient from the drug dispensing kiosk is initiated by a human so as to be as a subjective dispensing decision.

### RELATED APPLICATIONS

This application claims priority to U.S. Provisional Application Ser. No. 62/039,687, titled “Kiosk Dispenser Interactive Original Order Entry Software Application,” filed on Aug. 20, 2014, which is incorporated herein by reference.

### FIELD

Implementations generally relate to placing an electronic order to fill a new prescription for a pharmaceutical prescribed by a healthcare provider to a patient, where the patient electronically consults with a pharmacist who initiates an electronic order to dispense the prescription from a drug-dispensing kiosk remotely located from the pharmacist.

### BACKGROUND

The use of the web by computing devices is a growing and ubiquitous factor for customers searching for and finding offers to transaction with merchants. While applications installed on such devices include those by which a customer-patient can request that a prescription for a pharmaceutical be refilled by a merchant-pharmacist, it would be an advance in the art of commerce to provide an application that allows a customer-patient to use their web enabled computing device to request that a new prescription for a drug prescribed by a healthcare provider to the customer-patient be filled by way of an electronic order from a remotely located merchant-pharmacist to a drug dispensing kiosk remotely located from the merchant-pharmacist.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic illustrating an exemplary network of patient devices executing one or more applications and having telecommunication capabilities, a prescription drug (Rx) processor, a Remote Pharmacist (RPh) Kiosk Control Platform, Rx Dispensing Kiosks, telecommuting Remote Pharmacist, and databases, where the network facilitates communications by which a patient can receive a prescription for a new drug prescribed by a healthcare provider, and can use the patient's computing device to communicate a request to fill the new prescription by way of a drug dispensing kiosk and/or a retail pharmacy which may involve patient counseling by a remote pharmacist via telecommunications capability of the patient device and/or the drug dispensing kiosk;

FIG. 2 is a partial cut-away view of a screen shot characterizing an exemplary user interface for displaying information pertaining to the downloading and installation of a software application to be executed on a patient device to request, among other requests, that a new prescription prescribed by a healthcare provider to a patent be filled by a pharmacist;

FIG. 3 is a partial cut-away view of a screen shot characterizing an exemplary user interface to display information rendered by the software application of FIG. 2, where the rendered information includes a plurality of icons each initiating a capability of the application, where one such capability is for using the patient device to request that a new prescription prescribed by a healthcare provider to a patent be filled by a pharmacist;

FIG. 4 is a partial cut-away view of a screen shot characterizing an exemplary user interface to display information rendered by the software application of FIG. 2, where the rendered information includes icons to each initiate respective capabilities of the application to permit input of patient profile information, including contact information for a patient, cards and related accounts providing information to identify the patient to third parties, payment card and related accounts for the patient including pharmaceutical insurance and benefit plan information for the patient, and options for obtaining and waiving consulting for the patient by a pharmacist filling the new prescription;

FIG. 5 is a partial cut-away view of a screen shot characterizing an exemplary user interface to display information rendered by the software application of FIG. 2, where the rendered information includes icons to each initiate respective capabilities of the application to permit input of those pharmacies that the patient prefers to fill a new prescription for a pharmaceutical, where these and other such patient preferences can be stored in the patient profile information as described with respect to FIG. 4;

FIG. 6 is a partial cut-away view of a screen shot characterizing an exemplary user interface to display information rendered by the software application of FIG. 2, where the rendered information includes icons to each initiate respective capabilities of the application to permit input of a selection by a user of the patient device to request the filling a new prescription for a pharmaceutical, to request the refilling of an existing prescription for a previously filled pharmaceutical, and to input other user selectable options;

FIG. 7 is a partial cut-away view of a screen shot characterizing an exemplary user interface to display information rendered by the software application of FIG. 2, where the rendered information includes an image captured by an image capture device of the patient device, where the captured image is that of a new prescription for a pharmaceutical that is to be filled for the patient, where the new prescription is to be filled by way of the patient device transmitting a request for same for delivery to a logical address associated with a pharmacy identified by information rendered on the user interface;

FIG. 8 is a partial cut-away view of a screen shot characterizing an exemplary user interface to display information rendered by the software application of FIG. 2, where the rendered information includes, among other data, a rendering of a map showing locations at which the new prescription for a pharmaceutical can be filled for the patient from drug inventory maintained at the displayed locations, an icon to activate renderings of various price and payment options selectable the user by which payment can be made for the new prescription to be filled, as well as an icon to activate renderings of delivery options selectable the user by which the new prescription can be filled and then delivered to the patient's residential address(es);

FIGS. 9-11 are respective flowcharts illustrating an exemplary process that can be executed on the network illustrated in FIG. 1, where the process included method steps by which a patient device executing an application, a prescription drug (Rx) processor, a remote pharmacist (RPh) Kiosk Control Platform, a Rx Dispensing Kiosk, and a telecommuting remote pharmacist facilitate network communications by which a patient can receive a prescription for a new drug prescribed by a healthcare provider, and where the application executing on the patient device can be used to communicate a request to fill the new prescription by way of a drug dispensing kiosk and/or a retail pharmacy which may involve patient counseling by a remote pharmacist via telecommunications capability of the patient device;

FIG. 12 illustrates a schematic of an implementation of a drug dispensing kiosk shown in FIG. 1, where the kiosk has an operating system and is a network device in communication over a network with other network devices and corresponding systems;

FIG. 13 illustrates conceptual diagram of an exemplary system and method in accordance with an implementation disclosed herein;

FIG. 14 illustrates creation of an electronic prescription in accordance an implementation disclosed herein;

FIG. 15 illustrates interaction between a patient and a drug dispensing kiosk in accordance with an implementation disclosed herein;

FIG. 16 illustrates an example of a combination prescription label and receipt generated by an implementation of a drug dispensing kiosk disclosed herein;

FIG. 17a-17b illustrate, respectively, a perspective view of an implementation disclosed herein of the automated apparatus for dispensing medicaments, wherein two, side-by-side front end user-interface modules share one back end drug vault module, and a perspective view of another implementation disclosed herein of the automated apparatus for dispensing medicaments, comprising four, side-by-side front end user-interface modules and two back end drug vault modules, whereby each of two side-by-side front end modules share one back end drug vault module;

FIGS. 18-20 illustrate an exemplary implementation having levels of access security for which a front of a prescription drug dispensing kiosk can be opened via controlled access to gain access to user interface components of the prescription drug dispensing kiosk and to service components of the prescription drug dispensing kiosk that are accessible at respective different security levels;

FIG. 21 illustrates an exemplary implementation having another level of access security for which a back end drug vault module of the prescription drug dispensing kiosk, containing medicaments, can be accessed;

FIG. 22 illustrates a side sectional view of an example of a back end drug vault module of an automated prescription drug dispensing kiosk implementation disclosed herein, wherein the prescription drug dispensing kiosk has a drug container pick module, a drug container labeling module, a controlled room temperature top section, and a controlled refrigerated bottom section;

FIG. 23 is a side elevation view of a labeling station of the drug container labeling module seen in FIG. 22 in an exemplary prescription drug-dispensing kiosk, and showing positioning of the elements thereof in the course of a label printing process according to an implementation disclosed herein; and

FIGS. 24-35 show respective screen shots each characterizing an exemplary user interface for displaying information pertaining to a software application executed on a web enabled mobile computing device to request, among other requests, that a new prescription prescribed by a healthcare provider to a patent be filled by a pharmacist;

Implementations will become more apparent from the detailed description set forth below when taken in conjunction with the drawings.

### DETAILED DESCRIPTION

In the following description, reference is made to the accompanying drawings that form a part of the present disclosure, and in which are shown, by way of illustration, specific implementations of the invention. These implementations are described in sufficient detail to enable those skilled in the art to practice the invention, and it is to be understood that other implementations may be utilized and that structural, logical, software, electrical and other changes may be made without departing from the scope of the present invention. The present disclosure is, therefore, not to be taken in a limiting sense. The present disclosure is neither a literal description of all implementations of the invention nor a listing of features of the invention which must be present in all implementations.

Numerous implementations are described in this patent application, and are presented for illustrative purposes only. The described implementations are not intended to be limiting in any sense. The invention is widely applicable to numerous implementations, as is readily apparent from the disclosure herein. Those skilled in the art will recognize that the present invention may be practiced with various modifications and alterations. Although particular features of the present invention may be described with reference to one or more particular implementations or figures, it should be understood that such features are not limited to usage in the one or more particular implementations or figures with reference to which they are described.

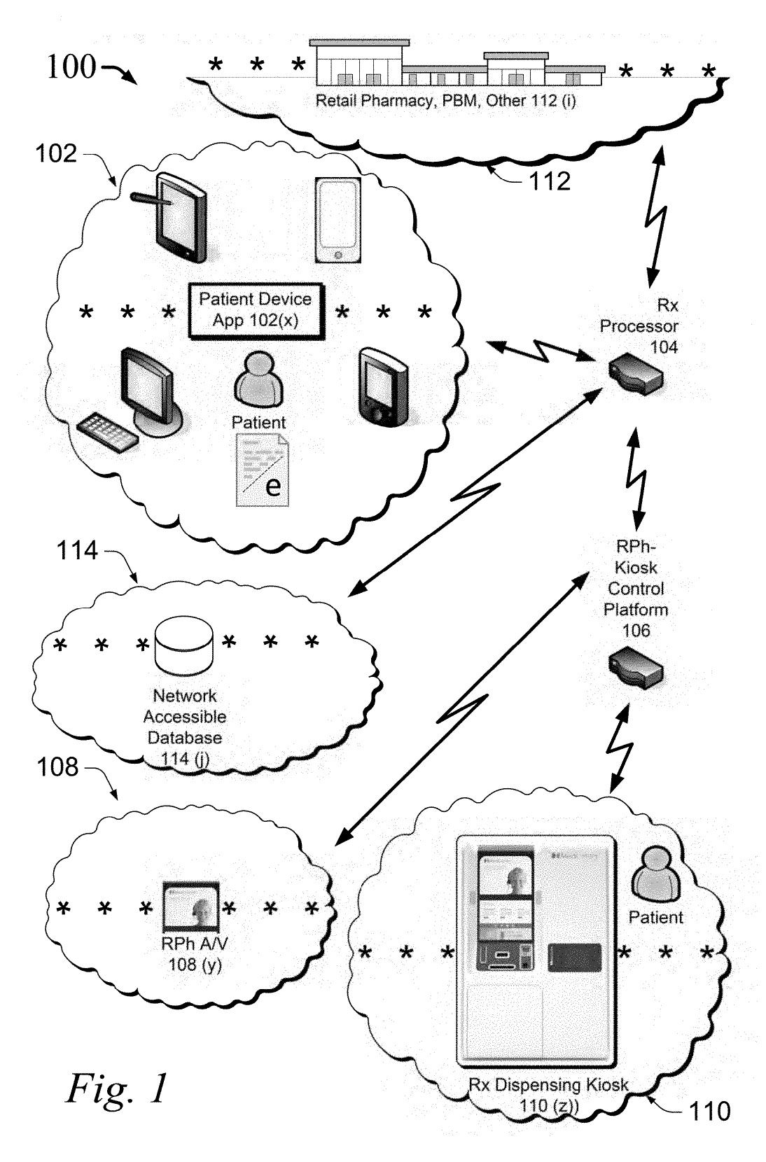

Referring now to FIG. 1, a network environment 100 is depicted that provides hardware, software, and interoperating capabilities by which a patient can use a web enabled computing device in a process through which the patient can have a pharmacist fill a new prescription for a pharmaceutical that was prescribed to the patient by a healthcare provider.

Reference numeral 102 shows a plurality of clients each executing an operating system. The clients 102 each have a Patient Device Application (App) 102(x) installed to be executed via its operating system, where ‘x’ is an integer from 1 to X. The clients 102 each can be a thick client or a thin client, that is, a web enabled mobile computing device, a desktop computer, and or a client having computational capabilities there between. The clients 102 each will preferably have, or will be in communication with, an image and/or audio capture device by which the client can conduct video teleconferencing, teleconferencing, and/or still image capturing.

A prescription (Rx) Processor 104 is in communication over a network, such as the internet, with each Patient Device App 102(x), a Remote Pharmacist (RPh) Kiosk Control Platform 106, with a plurality of Remote Pharmacists (RPh) A/V 108, with a plurality of prescription (Rx) Dispensing Kiosks 110, and optionally with a plurality of Network Accessible Databases 114.

Each pharmacist, and/or agent thereof, RPh A/V 108(y) includes has video teleconferencing and/or teleconferencing capabilities, where ‘y’ is an integer from 1 to ‘Y’. Each Rx Dispensing Kiosk 110(z) has video teleconferencing and/or teleconferencing capabilities with Patient Device App 102(x), where ‘z’ is an integer from 1 to Z. As such, the remote pharmacist at RPh A/V 108(y) can provide counseling to a patient using Rx Dispensing Kiosk 110(z).

Rx Dispensing Kiosk 110(z) can receive a signal from the remote pharmacist at RPh A/V 108(y) via network communications. This signal gives an instruction to dispense a prescription drug container to the patient using Rx Dispensing Kiosk 110(z). This container for the patient's prescription will have been picked from the kiosk's inventory and will have been labeled by a labeling component in Rx Dispensing Kiosk 110(z). The label is specific for the patient as a dispensed prescription. Preferably, the Rx Dispensing Kiosk 110(z) will not dispense a drug from the inventory therein without authorization of the remote pharmacist RPh A/V 108(y). Stated otherwise, a human agent remotely controls the drug dispense operation of Rx Dispensing Kiosk 110(z), and while computer controls assist in the drug dispense operation, a drug will not be dispensed from Rx Dispensing Kiosk 110(z) without intervention by a human agent.

Each Network Accessible Database 114(j), where ‘j’ is an integer from 1 to T, can be accessible to Rx Processor 104, and other network devices, over via network communications. The content and/or data structures in each Network Accessible Database 114(j) facilitates filling a new prescription for a patient using a Patient Device App 102(x) at a Rx Dispensing Kiosk 110(z), or at or by any of a plurality of entities 112, such as at or by a Retail Pharmacy, a Pharmacy Benefits Manager (PBM), or another entity 112(i), where T is an integer between 1 and ‘I’.

Each Network Accessible Database 114(j) can be connected to one more private or public networks, virtual private networks, the Internet, or by other means known to those skilled in the art or that will be known. Moreover, not every entity seen in FIG. 1 must necessarily have real time, uninterrupted access to any or all of the Network Accessible Databases 114. Each such Network Accessible Database 114(j) can be assigned, read, written, and be subject to query permissions as appropriate to the various entities shown in FIG. 1.

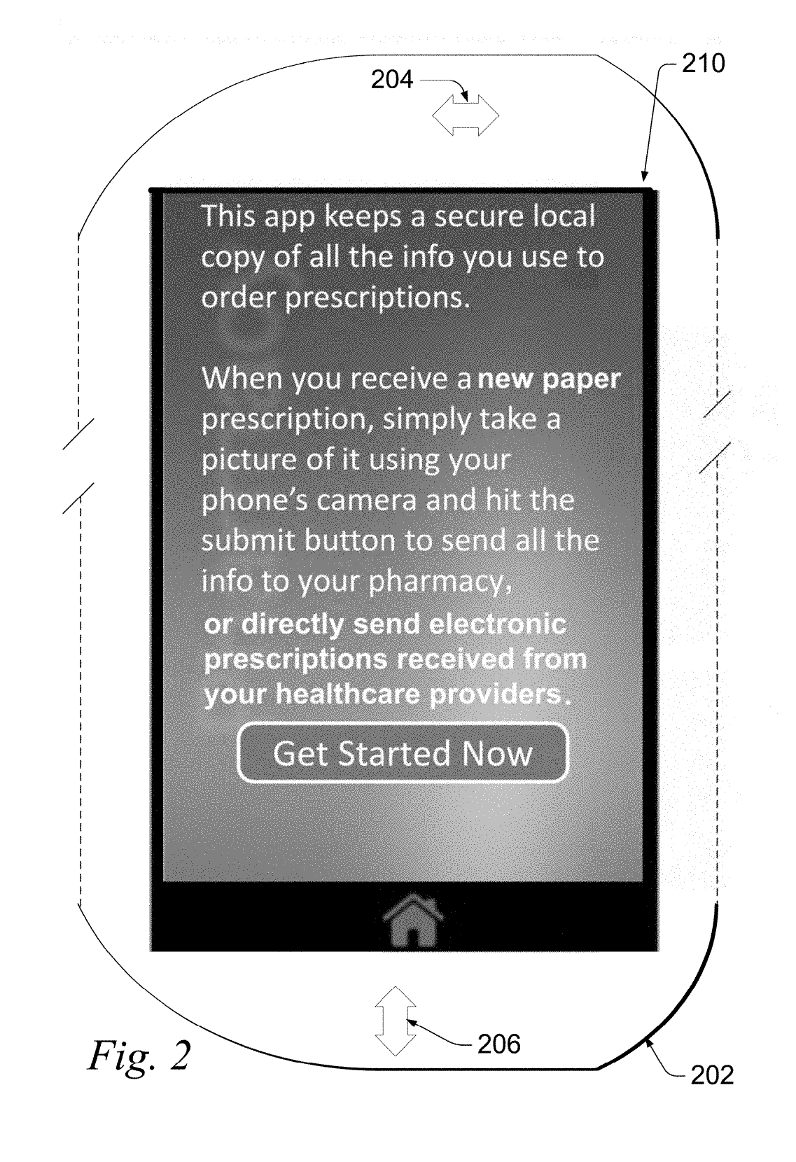

Referring now to FIGS. 1-2, the clients 102 each can transmit a request over the network environment 100 to Rx Processor 104 to receive and install Patient Device App 102(x). Upon such installation of Patient Device App 102(x) on the client, as seen in FIG. 2, a splash screen 210 for the installed App 102(x) can be rendered on a display screen 202 of the client. As is conventional of a user interface for an installed ‘App’, navigational icons 204, 206 provide horizontal and vertical movement of the rendered screen 210, respectively.

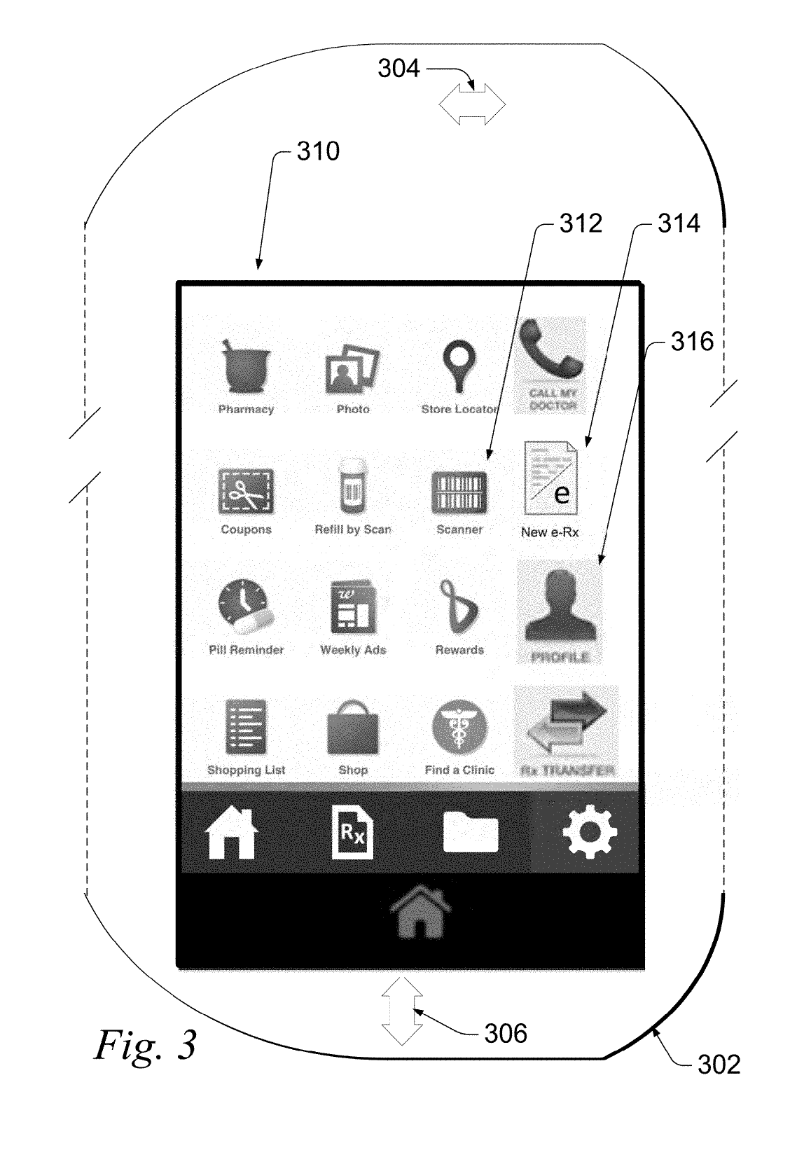

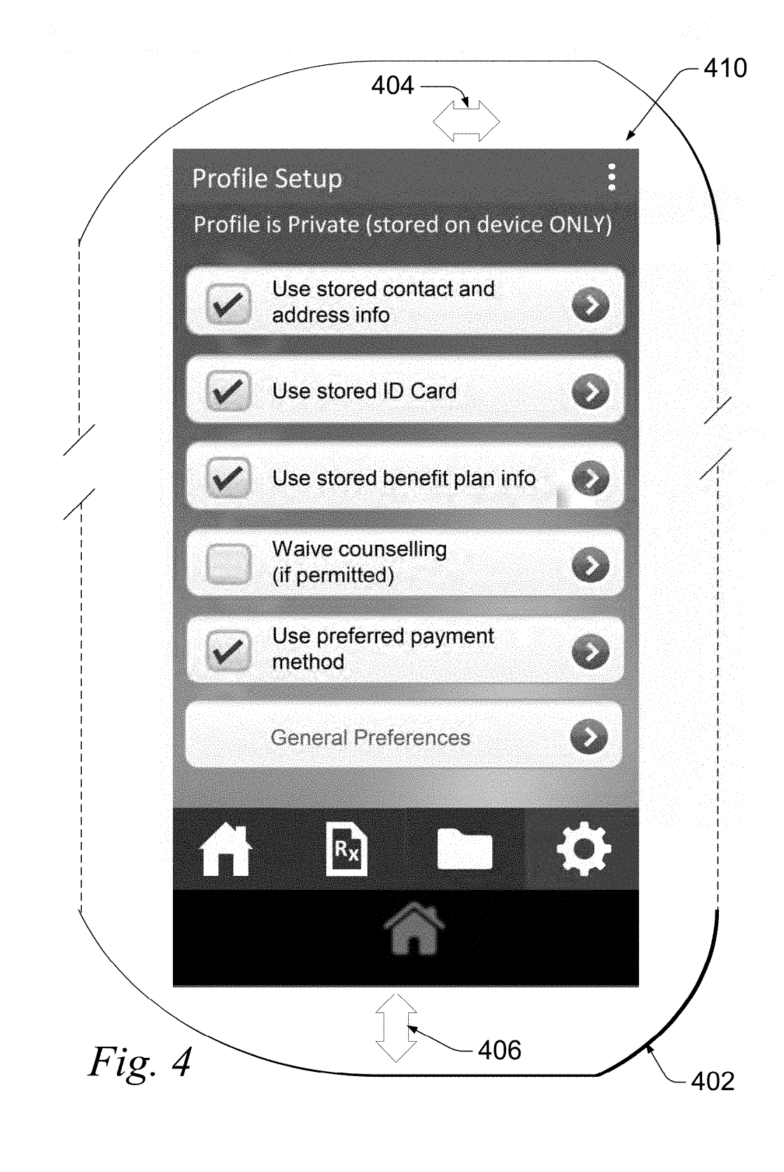

Referring now to FIG. 3, a plurality of icons are rendered on display screen 302 each depicting a respective function that can be executed by the installed Patient Device App 102(x) on the client. One such function, seen at reference numeral 312, activates an image capture device (e.g., a camera) of the client so that a patient, or agent thereof, can take and store a picture of a paper prescription for a new prescription drug that has been prescribed by a healthcare provider to the patient. Another function, seen at reference numeral 314, is function used when the client has received and stored a new electronic prescription (e.g., e-script) for a drug that has been prescribed by a healthcare provider to the patient. As such, icon 314, when activated, initiates a process by which there will be a transmission of the stored e-script to a pharmacist so that the new prescription (e.g., not a refilled prescription) can be filled. Yet another function, seen at reference numeral 316, is a function used by a user of the client to make manual input of personal information to be stored internally in the client or in a network accessible device. This personal information, further discussed herein with respect to FIG. 4, can be directly or indirectly transmitted so as to be provided to a pharmacist, or agent thereof, for use in a process of filling a prescription for a new drug that has been prescribed by a healthcare provider to the patient. As is conventional of a user interface for an installed ‘App’, navigational icons 304, 306 provide horizontal and vertical movement of the rendering 310 on display screen 302.

Referring now to FIG. 4, icons are rendered on display screen 402 each depicting a respective function that can be executed by the installed Patient Device App 102(x). Each function allows a user of the client to perform manual input of personal information. After such manual input by the user, the stored personal information can be transmitted to one or more entities incident to the patient having a new prescription filled by a pharmacist. By way of example, and not by way of limitation, these personal data include contact and address information for healthcare providers, pharmacists and pharmacies, and information to identify the patient such as date of birth, residential address, citizenship, passport identifiers, etc. Other such personal data includes a designation whether or not, when a new prescription drug is being filled for the patient, the patient wishes not to receive counseling from the pharmacist who is filling the new prescription for the patient. Note that this option may not be available, due to pharmaceutical regulations for some new prescriptions. Yet other such personal data includes one or more accounts on which payment, full and/or partial, can be made for a patient's prescription. This payment account information (not shown) can include debit accounts, revolving credit accounts, spot credit accounts, checking and savings accounts, governmental and employment benefits accounts, gift card accounts, etc. Other general preferences can be input by the user such as whether a patient prefers to travel a preferred distance in order to pick-up a new prescription that has been filled by a pharmacist, or whether the patient's preference is to have the new prescription delivered by one or more preferred delivery methods to one or more preferred addresses at corresponding selection of delivery costs. As is conventional of a user interface for an installed ‘App’, navigational icons 404, 406 provide horizontal and vertical movement of the rendering 410 on display screen 402.

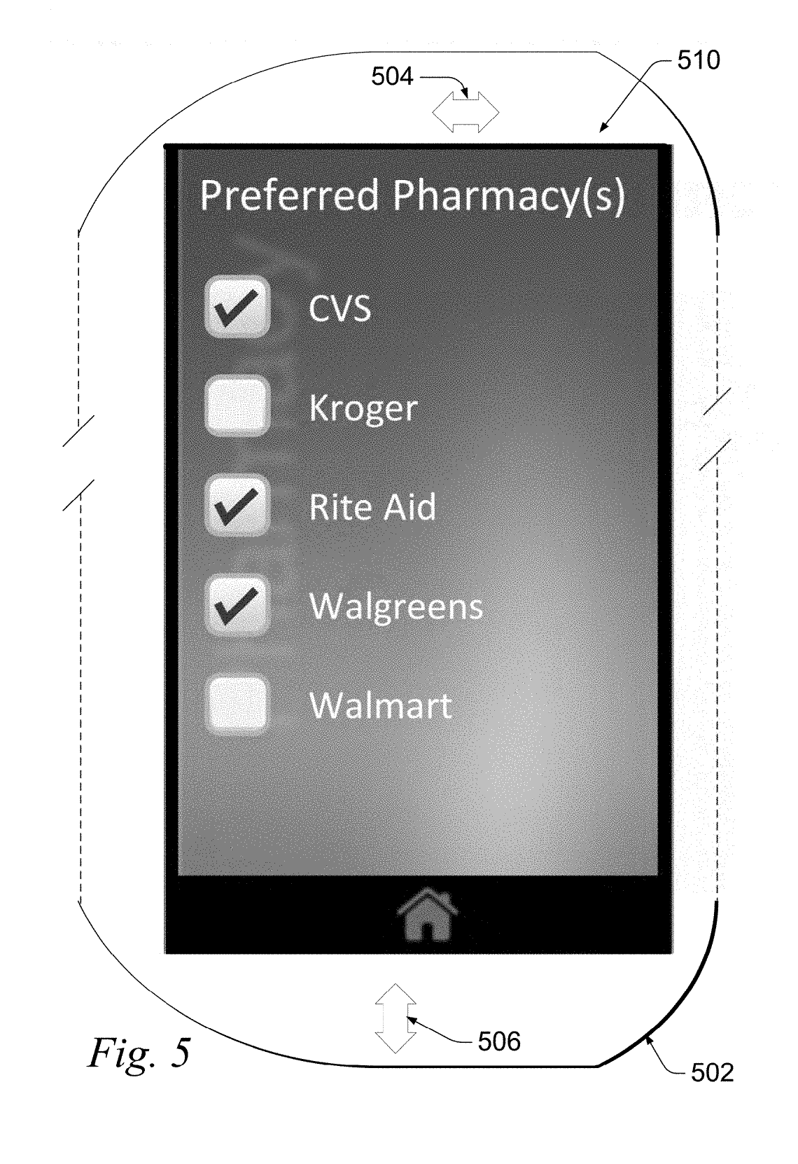

Referring now to FIG. 5, icons are rendered at reference numeral 510 on display screen 502 each depicting a different retail pharmacy selectable by a patient to show a preference for a pharmacist associated with the selected pharmacy to fill a new prescription for the patient. As is conventional of a user interface for an installed ‘App’, navigational icons 504, 506 provide horizontal and vertical movement of the rendering 510 on display screen 502.

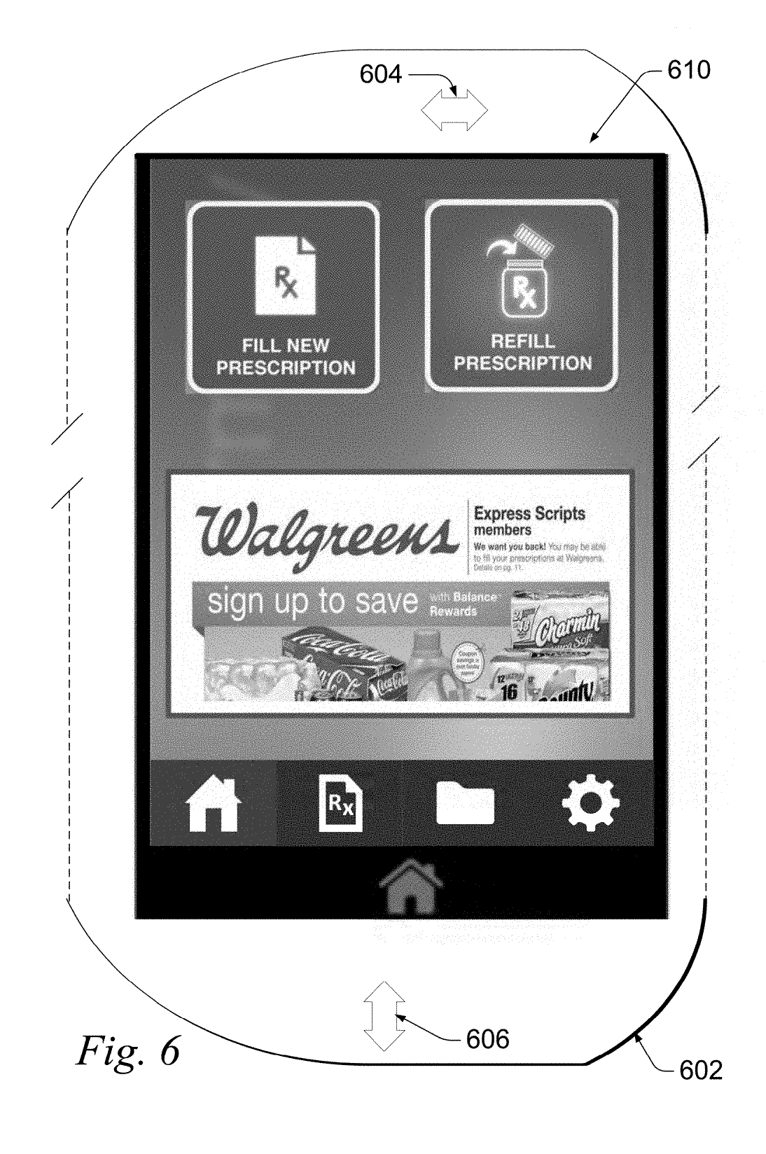

Referring now to FIG. 6, icons are rendered at reference numeral 610 on display screen 602 each depicting a function selectable by a user of the one client 102. Once such function initiates a process by which a patient can submit a new prescription to be filled by a pharmacist, and another function initiates a process by which a patient can submit a prescription to be refilled by a pharmacist. Also, there can be rendered on display screen 602 one or more advertisements, coupons, alerts, notices, etc. each of which can be retrieved from one or more network assessable databases 114. As is conventional of a user interface for an installed ‘App’, navigational icons 604, 606 provide horizontal and vertical movement of the rendering 610 on display screen 602.

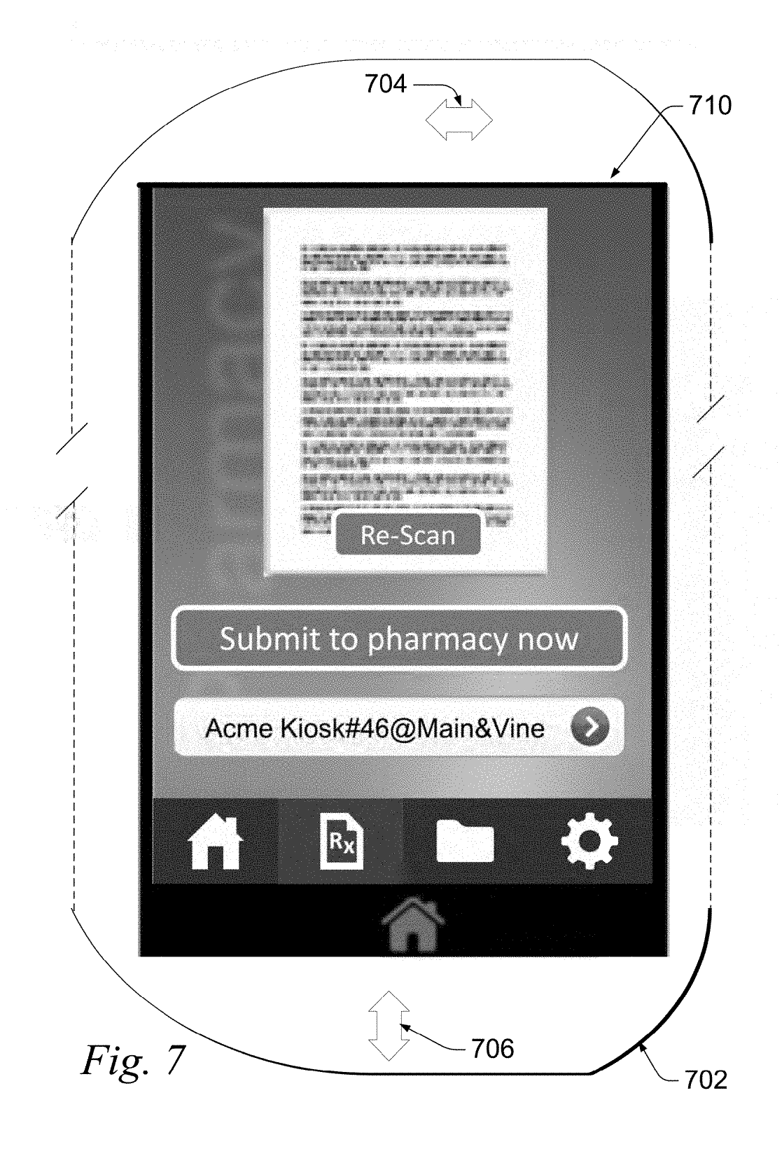

Referring now to FIG. 7, a captured image of a patient's prescription is rendered on display screen 702. By way of example, and not by way of limitation, the image can be captured by a camera in communication with, or part of, the client on which installed Patient Device App 102(x) is executing, such as where the icon seen at reference numeral 312 in FIG. 3 was activated to capture an image of a paper prescription written, or printed, by a healthcare provider after the corresponding drug was prescribed by a healthcare provider for the patient. Another icon rendered on display screen 710 activates a process by which the rendered prescription is transmitted to a pharmacy to be filled by a pharmacist. Another field rendered on display screen 710 shows an identifier for a drug dispensing kiosk that is to be used by a remote pharmacist to dispense the rendered prescription to the patient. As is conventional of a user interface for an installed ‘App’, navigational icons 704, 706 provide horizontal and vertical movement of the rendering 710 on display screen 702.

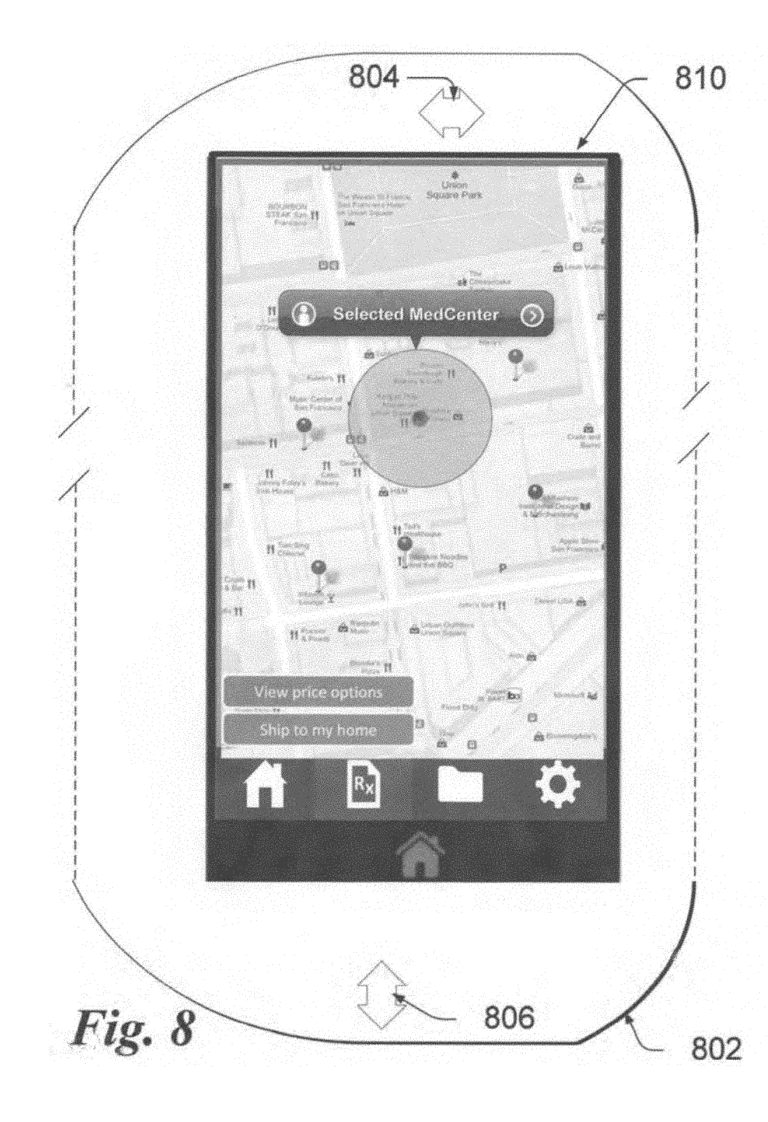

Referring now to FIG. 8, a map 810 is rendered on display screen 802. Map 810 depicts a plurality of locations where inventory is located sufficient to fill a prescription for a drug that has been prescribed to a patient by a healthcare provider. A highlighted portion of the map indicates a remote drug-dispensing kiosk that has been selected by a function of installed Patient Device App 102(x) to fill and dispense the prescribed drug to the patient. Also shown are rendered icons on display screen 802 that correspond to selectable functions. One such function of installed Patient Device App 102(x) is to view various rendered price options selectable by the patient to pay for the prescribed drug. Another such function of installed Patient Device App 102(x) is to view various selectable delivery options by which the prescribed drug will be delivered to a residential address of the patient to whom the drug was prescribed. By way of example, and not by way of limitation, the map 810 can include pharmacies that are specific to a location associated with a patient such as or or more employment and/or residential locations.

Each pharmacy on Map 810 can be a those derived from navigation (distance/time) calculations made by using: (i) identifiers for the current geographic location of the client as derived from the client's geo-location functionalities; and (ii) information retrieved by access of one or more Network Accessible Databases 114 which may include geographic and/or cartographic map data for navigating by walking, bicycling, automobile, and/or public transportation. Each such calculation may derive the distance between the present location of the client and the pharmacy having inventory to fill the patient's prescription, and may also or alternatively derive the time for the patient to navigate to the pharmacy by walking, bicycling, automobile, and public transportation. The various locations that can be associated with a patient include a local community, a geographic region, a political region, a demographic region, a region corresponding to one or more public transportation modes, a region corresponding to one or more navigational algorithms for various geopolitical regions, a region corresponding to specific or general cartographic data, a planned community, a region based upon population density, a region based upon predetermined cultural divisions, a region based upon governmental census statistics, a region based upon predetermined socio-economic factors, and combinations thereof. As is conventional of a user interface for an installed ‘App’, navigational icons 804, 806 provide horizontal and vertical movement of the rendering 810 on display screen 802.

The screen shots shown in FIGS. 2-8 may be further enhanced with functionalities for various implementations of installed Patient Device App 102(x) as are typical of a user experience for ‘Apps’ installed on tablets, smart phones, phablets, and other web enabled mobile computing devices. Such enhancements include, but are not limited to, pull down menus of selectable options, input by way of software and/or hardware keyboard data entry, input by way of pictograph optical scanning from print or electronic media rendering, etc.

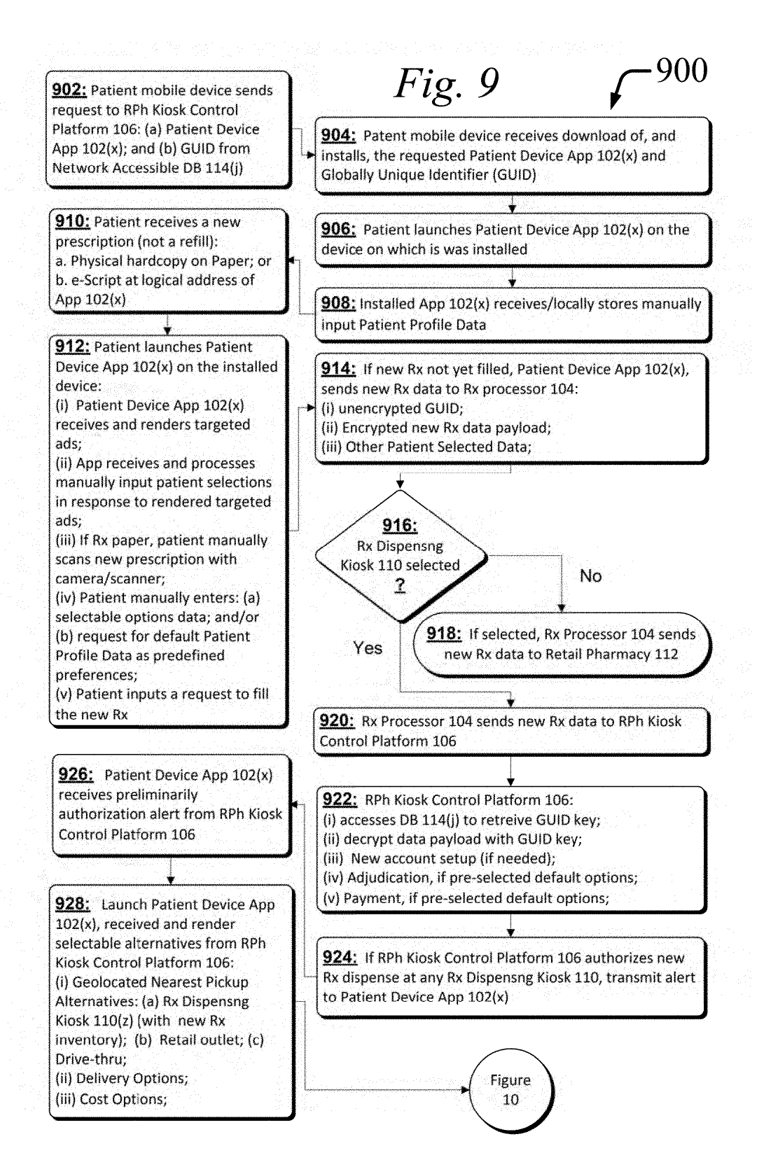

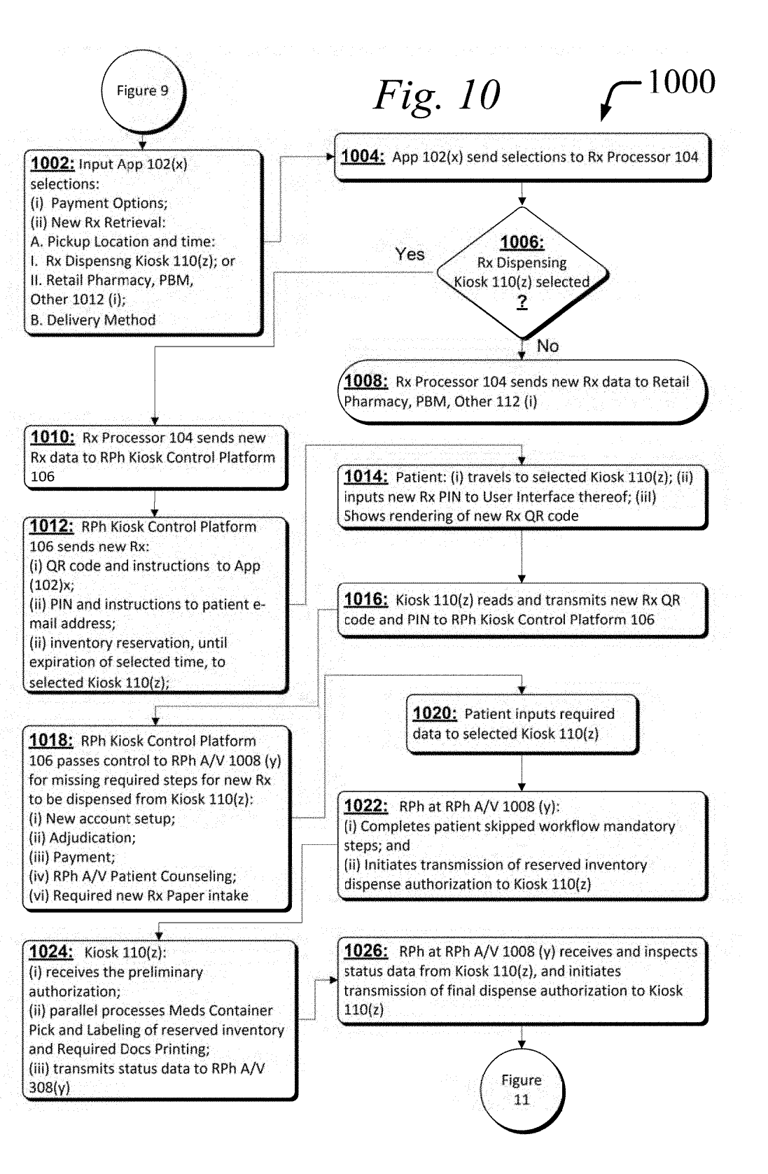

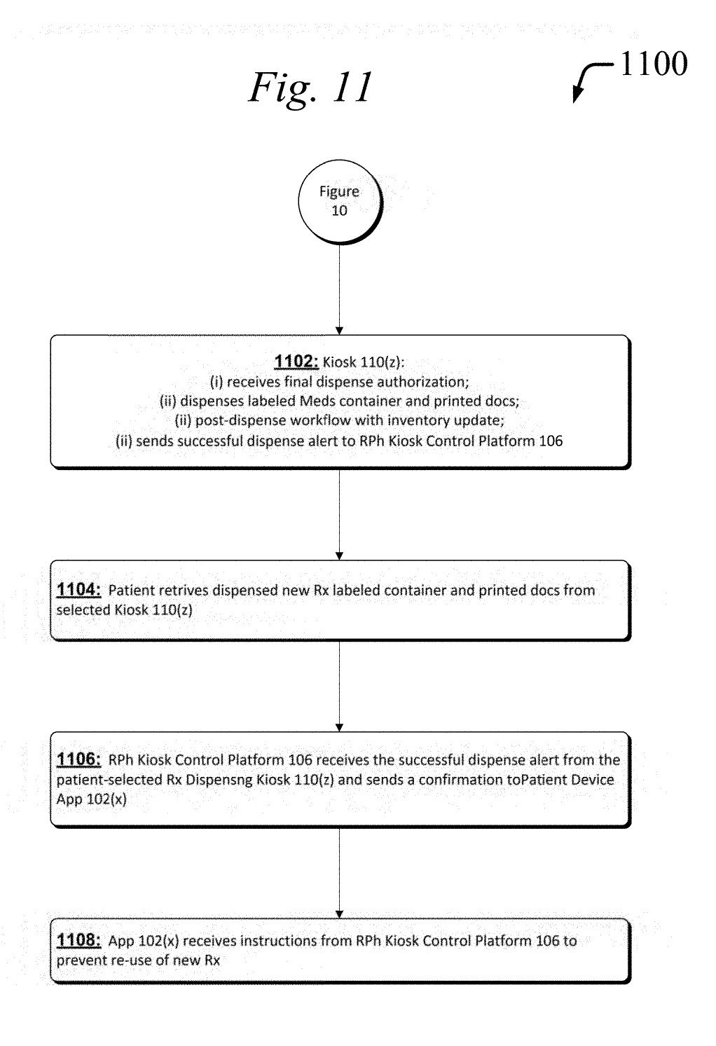

Referring now to FIGS. 9-11, steps for methods 900, 1000 and 1100 as are illustrated by reference numerals seen in the corresponding flowcharts thereof.

Referring now to FIG. 9 and in further reference to FIG. 1 as described above, a method 900 has a step 902 at which one client 102, as the personal computation device of a patient, which device may be mobile device, transmits a request to the RPh Kiosk Control Platform 106 to download: (i) the Patient Device App 102(x) for installation; and (ii) a Globally Unique Identifier (GUID) specific to the installed Patient Device App 102(x). The GUID served to the corresponding client 102(x) can be maintained in a Net Accessible Database 114(j) so as to be accessed, retrieved and specifically assigned to App 102(x) by the RPh Kiosk Control Platform 106.

At step 904 of method 900, the patient's mobile device 102(x) receives a download of, and installs, the requested Patient Device App 102(x) so as to be associated with the assigned GUID.

At step 906, the patient launches Patient Device App 102(x) on the device on which it was installed.

At step 908, the patient manually inputs Patient Profile Data to storage accessible to the installed device (i.e., local and/or network assessable storage). These data can include, but are not limited to, name(s), address(es), health insurance information, payment method data, image data of various payment account information typically associates with an embossed or printed card such as insurance cards, payment cards, membership cards, loyalty club cards, discount cards, etc.

At step 910, a patient receives a new prescription for a pharmaceutical drug or method (e.g., not a refill), or alternatively for a new medical laboratory test or procedure, where the prescription can be in the form of a physical hardcopy on paper, and/or by way of electronic delivery to a logical address accessible to Patient Device App 102(x).

At step 912, the patient launches Patient Device App 102(x) on the installed device. The Patient Device App 102(x) optionally receives, at a logical address accessible to Patient Device App 102(x), and renders targeted ads. The Patient Device App 102(x) optionally receives and processes manually input patient selections in response to rendered targeted ads. If the prescription received by the patient is on a piece of paper, the patient manually scans the paper prescription with a camera/scanner that is a peripheral device to the device on which Patient Device App 102(x) is installed. The patient manually enters into the Patient Device App 102(x)'s User Interface (UI): (i) selectable options data; and/or (ii) a request to use default Patient Profile Data as predefined preferences. The patient inputs a request to send the new prescription (Rx) that has yet to be filled.

At step 914, if the local data associated with the Patient Device App 102(x) and the new Rx shows that the new Rx has not yet been filled, then Patient Device App 102(x) prepares a data payload for transmission. The data payload will preferably include the assigned GUID in an unencrypted form, and encrypted data pertaining to Rx that may include a paper scan and/or an electronic prescription (e.g., e-script). This data payload is sent by the one device 102 to the logical address of the Rx processor 104. Note that the Patient Device App 102(x), via the one device 102, sends data to the logical address of Rx processor 104, which can be a server farm, where the transmission can be via a packet switched network, and where the transmission can include an unencrypted portion having the assigned GUID for the patient who installed Patient Device App 102(x), and other Patient Selected Data, and can include an encrypted data portion that pertains to the Rx and is confidential to the patient and the patient's healthcare provider.

To preserve and enhance data privacy and security for the patient when requesting that a new prescription be filled, data encryption can be used. Rx processor 104 will preferably not have access to a decryption key that would otherwise enable access to patient data including insurance, payment and health related data. In contrast, RPh Kiosk Control Platform 106 will preferably have access to a decryption key by way of using the GUID assigned to Patient Device App 102(x). Such access allows Platform 106 to send confidential date to financial institutions that may have issued accounts to the patient for the purpose of making payments and/or performing authorization, authentication and/or payment processing routines.

At step 916, the Rx Processor 104 determines if unencrypted data shows that an Rx Dispensing Kiosk 110(z) is involved. If not, as shown at Step 918, then the Rx Processor 104 repackages the data payload and sends it to Retail Pharmacy 112(i) according to options previously selected by the patient by using Patient Device App 102(x), such as may have been manually input by patient to the Patient Device App 102(x), and/or by way of default data stored in the Patient Profile Data as predefined preferences.

If Rx Dispensing Kiosk 110(z) is involved, then Rx Processor 104, at step 920, repackages the data payload and sends same to the logical address of the RPh Kiosk Control Platform 106.

At step 922, the RPh Kiosk Control Platform 106: (i) accesses DB 114(j) to retrieve the GUID that corresponds to the payload received from Rx Processor 104; (ii) decrypts data in the payload using the retrieved GUID; (iii) performs a new account setup (if needed); (iv) performs an adjudication process for the new prescription, if pre-selected by way of previously stored default options; and (v) performs a payment process to pay for the prescription, if pre-selected by way of previously stored default options. Note that the data payload is decrypted using a key associated with the GUID as stored in network database 114(i) that is accessible by the RPh Kiosk Control Platform 106.

At step 924, a remotely located pharmacist, seen in FIG. 1 as RPh A/V 108(y), reviews the request for the new prescription as electronically received from RPh-Kiosk Control Platform 106. Using professional objective medical judgement and subjective medical judgement, the pharmacist completes the review and tentatively and preliminarily authorizes a dispense of the prescription for the new drug, although the location of the dispense will be from available inventory within an Rx Dispensing Kiosk 110(z) that has yet to be selected or confirmed. Then, the RPh Kiosk Control Platform 106 transmits an alert for delivery at the logical address of the Patient Device App 102(x).

At step 926 the Patient Device App 102(x) receives the alert from the RPh Kiosk Control Platform 106 that the remotely located pharmacist, seen in FIG. 1 as RPh A/V 108(y), has tentatively and preliminarily authorized a dispense of the prescription at a Rx Dispensing Kiosk 110(z) that has yet to be selected or confirmed.

At step 928, the patient, in response to the received alert, launches Patient Device App 102(x) on the installed device. The Patient Device App 102(x) renders alternatives for patient selection on the Patient Device App 102(x). The alternatives rendered as selectable options by Patient Device App 102(x), after the alert has been received from RPh Kiosk Control Platform 106, can include: (i) Geolocated Nearest Pickup Alternatives, for example as shown in FIG. 8, including but not limited to a Rx Dispensing Kiosk 110(z) having sufficient inventory to fill the patient's prescription, a retail outlet that has a pharmacy, a drive-thru pharmacy, one or more delivery options, one or more options for the patient to pay for the prescription, etc.

After step 928, method 1000 can begin at step 1002 at which the patient can use the Patient Device App 102(x) to enter selections from among those options that are rendered by Patient Device App 102(x). As such, the patient can select from among various places where the new prescription is to be picked up, such as the nearest Rx Dispensing Kiosk 110(z), the nearest retail outlet, the nearest drive thru pharmacy facility, the date-hour time slot that the patient agrees to arrive and pick up the prescription corresponding to when the pickup will also be available. The patient can also select from among various delivery alternatives for the new prescription, including carrier selections by cost of delivery and delivery location(s) as well as the date-hour time slot that the delivery of the new prescription will be delivered by the selected carrier. The patient can also select from among various least expensive alternatives, such a payment from a tax favored account such as a Health Saving Account (HSA), a Medical Savings Account (MSA), a government benefits account, a payment without the benefit of health insurance, an option to request that the prescription be filled by a generic of unpatented drug as opposed to a ‘dispense-as-written’ or patented drug.

At step 1004 of Method 1000, Patient Device App 102(x) sends the patient's input selections to Rx Processor 104 for further handling, where the data received by Rx Processor 104 from Patient Device App 102(x) may be substantially encrypted, in whole or in part, so as to preserve and protect patient data security and confidentiality.

At step 1006, a determination is made as to whether or not the patient has selected a specific and particular Rx Dispensing Kiosk 110(z) to pick up the new prescription. If not, the Rx Processor 104 sends the data to the patent selected Retail Pharmacy, PBM, Other 112 (i) as shown in FIG. 1. Otherwise, method 1000 proceeds to step 1010 at which Rx Processor 104 sends the data to RPh Kiosk Control Platform 106 in order to facilitate that the patient selected Rx Dispensing Kiosk 110(z) performing an inventory reservation of the prescribed drug to ensure its availability of the drug within a selected time slot when the patient has committed to arrive to pick up the new prescription.

At step 1012, RPh Kiosk Control Platform 106 sends data corresponding to the new prescription to the App 102(x). These data can include a graphic symbol, such as a computer readable graphic symbol (i.e., 2D QR code, barcode, etc.), and instructions for traveling to the selected Kiosk 110(z).

Also at step 1012, RPh Kiosk Control Platform 106 can send a Personal Identification character string or Number (PIN) via e-mail to a logical mail address assessable to the patient. The PIN can be a confirmation code or order number within an e-mail sent to the patient's email address. The e-mail can also include instructions for traveling to the selected Kiosk 110(z). Other information sent by transmissions to a logical address accessible by Patient Device App 102(x) can contain alterative dates and time periods when the preliminary order can be picked up at the selected Rx Dispensing Kiosk 110(z) (i.e., retail store hours when the patient-selected Rx Dispensing Kiosk 110(z) is accessible to the public).

Note that the data sent by Platform 106 to App 102(x) can include a warning that the inventory reserved to fill the patient's new prescription will no longer be available after the patient's selected pickup time period. That is, the inventory reservation in Kiosk 110(z) will expire, and no longer be committed for use by the patient, as of a date and time certain so as to free to be picked up by another patient wishing to obtain the drug from the Kiosk 110(z).

At step 1014, the patient travels to the selected Rx Dispensing Kiosk 110(z) at the selected time period during which inventory of the prescribed drug is available to be dispensed to the patient. The patient uses components of the UI of Rx Dispensing Kiosk 110(z) that allows the Rx Dispensing Kiosk 110(z) to read a two (2) dimensional (2D) computer readable symbol, such as a 2D QR code or barcode, from a screen rendering by App 102(x), or alternatively by way of a piece paper on which the symbol was printed for the patient. The patient may also be prompted to enter the PIN that was e-mailed to the patient, thereby facilitating a dual authentication required receipt of a scan of the computer readable symbol and the patient's assigned PIN. Such a step may be required and/or otherwise be desirable, to ensure the patient, and only the patient, will be have access to be able to pick up the new prescription at Rx Dispensing Kiosk 110(z).

At step 1016, the Rx Dispensing Kiosk 110(z) captures and optionally interprets the 2D QR code, and can optionally capture and interpret the PIN manually entered on UI of the Rx Dispensing Kiosk 110(z). The Rx Dispensing Kiosk 110(z) transmits to the logical address of the RPh Kiosk Control Platform 106: (i) the 2D QR code; (ii) PIN (if any); and (iii) other data input by the patient using the UI for Rx Dispensing Kiosk 110(z).

At step 1018, the RPh Kiosk Control Platform 106 determines skipped mandatory step(s), if any, per a kiosk prescription drug dispensing workflow for the new prescription that the patient has requested to be filled at the Rx Dispensing Kiosk 110(z). These include, but are not limited to, payment for the new prescription, health insurance adjudication of the new prescription, a requirement that the patient feed a paper prescription for the drug to be dispensed into a sheet feeder component or other paper handler, thereby confiscating the paper prescription form to prevent its reuse, and an audio or audio visual consultation by RPh A/V 108(y) to the patient via the UI of Rx Dispensing Kiosk 110(z), and/or via a UI of the patient's person client 102(x), as facilitated by the RPh Kiosk Control Platform 106.

At steps 1020-1022, the patient makes any remaining required and optional input via the UI of Rx Dispensing Kiosk 110(z), and the remote pharmacist RPh A/V 108(y) conducts any required or optional audio or audio visual consultation with the patient via the UI of Rx Dispensing Kiosk 110(z), and/or via a UI of the Patient Device App 102(x), as facilitated by the RPh Kiosk Control Platform 106.

Also at step 1022, the remote pharmacist RPh A/V 108(y) reviews data acquired via transmission from RPh Kiosk Control Platform 106 to determine whether or not the Rx Dispensing Kiosk 110(z) is ready to begin the new prescription dispensing process according to required and optional regulatory work flows. If so, then the remote pharmacist initiates a transmission for delivery to Rx Dispensing Kiosk 110(z) that authorizes the reserved inventory therein to be dispensed to the patient as the requested new prescription.

At step 1024, the Rx Dispensing Kiosk 110(z) receives the authorization transmission from the remote pharmacist via the RPh Kiosk Control Platform 106. The Rx Dispensing Kiosk 110(z) then begins an optional parallel processing function using the data it has received from the RPh Kiosk Control Platform 106. These processes can be performed in parallel so as to expedite the time that is required to dispense the new prescription to the patient. Such parallel processing can reduce the patient's wait time for the dispense, as well as that of other such patients queuing up for sequential access to the Rx Dispensing Kiosk 110(z) after access by the patient currently using the Rx Dispensing Kiosk 110(z). In particular, a drug container picking workflow is used to retrieve a medication from the inventory in the kiosk that corresponds to the prior inventory that had been reserved for the patient. Also, a patient-specific label is prepared and printed for the drug container that is being picked from inventory in a drug container labeling workflow. Also, a documentation workflow is performed in parallel with both the drug container retrieval workflow and the drug container labeling workflow.

At step 1026, data is transmitted back to the remote pharmacist RPh A/V 108(y). This data may include one or more captured images representative of what has occurred inside, and/or proximal to, the Kiosk 110(z) during each of the parallel processes of patient-specific labeling, drug container picking, and documentation printing workflows. If the data review conducted by the remote pharmacist RPh A/V 108(y) is satisfactory to the subjective and/or objective judgement of the remote pharmacist RPh A/V 108(y), the remote pharmacist RPh A/V 108(y) initiates a transmission of final dispense authorization to Kiosk 110(z) that is received from the RPh Kiosk Control Platform 106.

After step 1026, step 1102 begins in method 1100 where Rx Dispensing Kiosk 110(z) dispenses the new prescription in a patient-labeled medication container to the patient, and then initiates a post-dispense workflow. If the Rx Dispensing Kiosk 110(z) post-dispense workflow determines a successful dispense of the new prescription which is properly retrieved by the patient, a corresponding diagnostic can optionally be communicated to the remote pharmacist RPh A/V 108(y) from the Rx Dispensing Kiosk 110(z) via a transmission addressed to RPh Kiosk Control Platform 106 showing the successful dispense of the new prescription.

At step 1106, RPh Kiosk Control Platform 106 receives the successful dispense acknowledgement from Rx Dispensing Kiosk 110(z) and sends a transmission addressed to the Patient Device App 102(x) indicative of same.

At step 1108, the Patient Device App 102(x) receives the transmission from the RPh Kiosk Control Platform 106 containing instructions to update data showing that the new prescription has been filled such that the new prescription cannot be re-submitted for being filled again by use of the Patient Device App 102(x). The Patient Device App 102(x) updates data corresponding to the new prescription such that it cannot be re-submitted for being filled again by the Patient Device App 102(x).

Mobile Computing Device Application for New Prescriptions Ordering

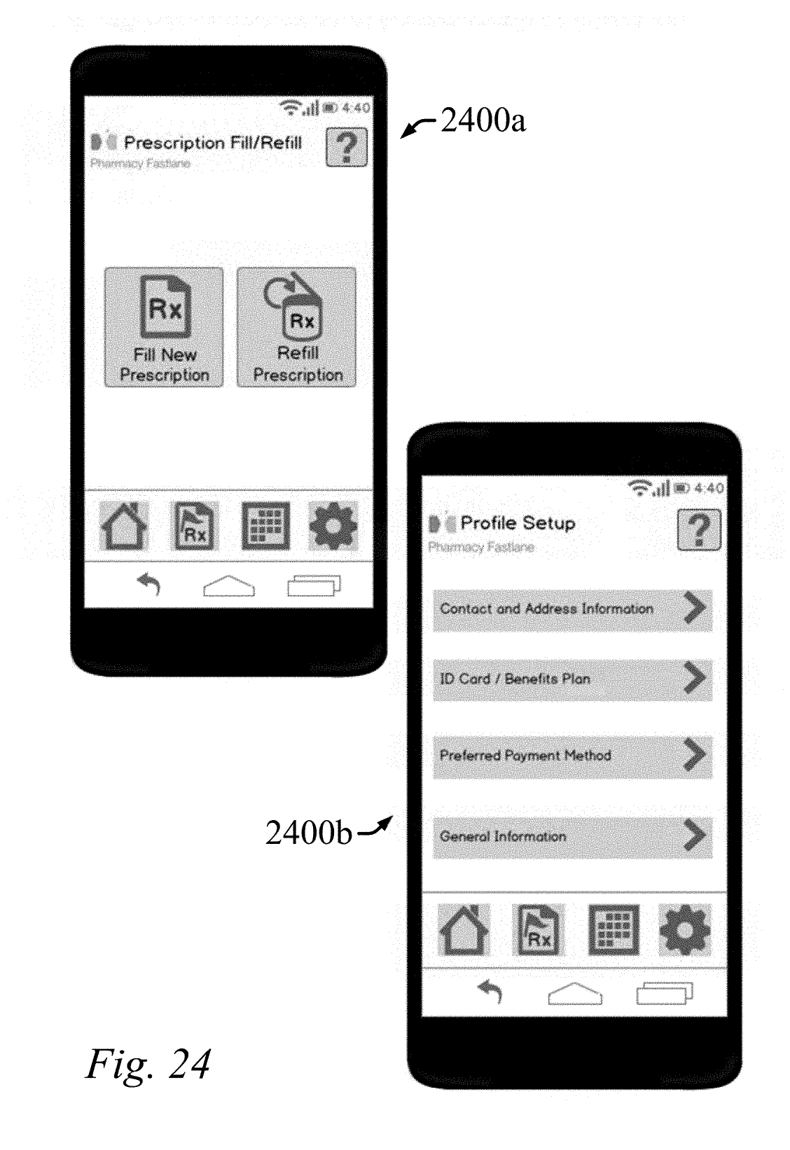

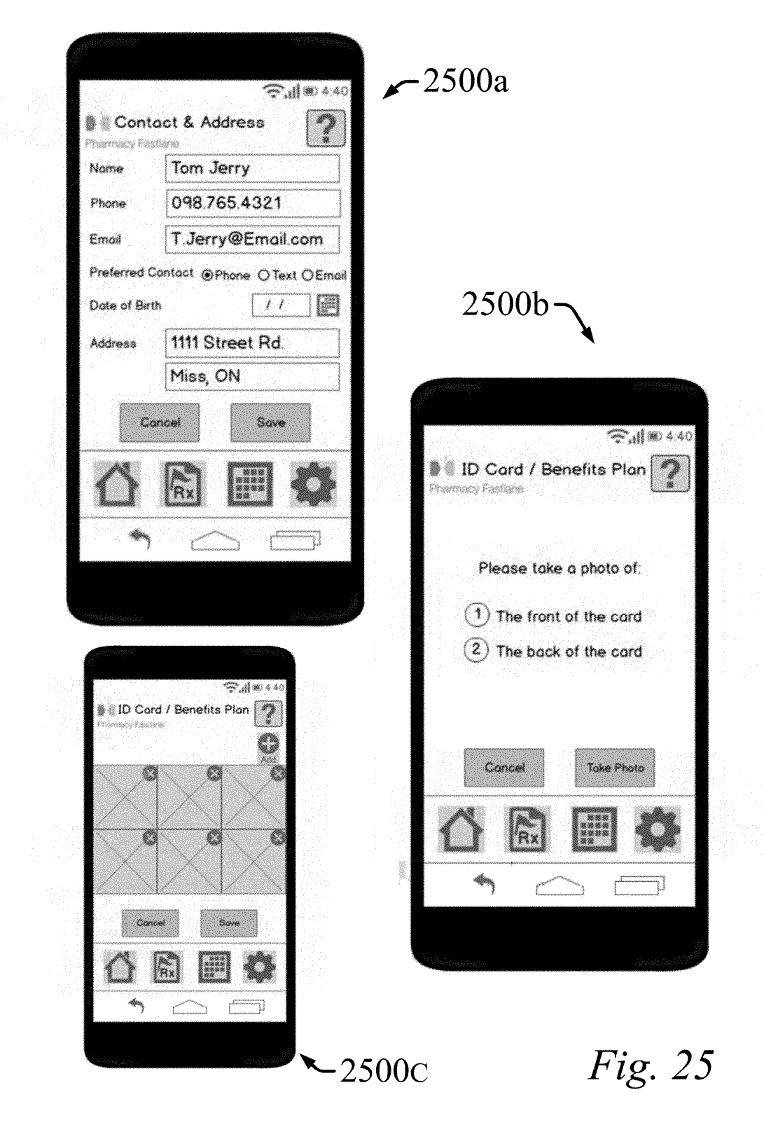

Referring now to FIGS. 1 and 24-30, the clients 102 each can transmit a request over the network environment 100 to Rx Processor 104 to receive and install Patient Device App 102(x) on a web enabled mobile computing device (e.g., tablet, smart phone, phablet). Upon such installation of Patient Device App 102(x) on the client, as seen in FIG. 24, a splash screen 2400a for the installed App 102(x) can be rendered on a display screen of the client. User selectable icons activate various functions of the application include a process to fill a new prescription prescribed by a healthcare provider to a patient, a process to refill a previously filled prescription for the patient, and a process for inputting information for storage and/or transmission by the application which information includes data of or relating to the patient. By way of example, the patient information can be include data shown with respect to the screen shot at reference numeral 2400b, including contact and address information, patient identification and benefits information, preferred payment methods, general information as is further discussed with respect to FIGS. 25-27.

FIG. 25 shows respective screen shots depicting fields where a user can input patient information. By way of example, the patient information can be include name, address and contact data shown with respect to the screen shot at reference numeral 2500a, and identification and benefits information shown with respect to the screen shot at reference numerals 2500b-c.

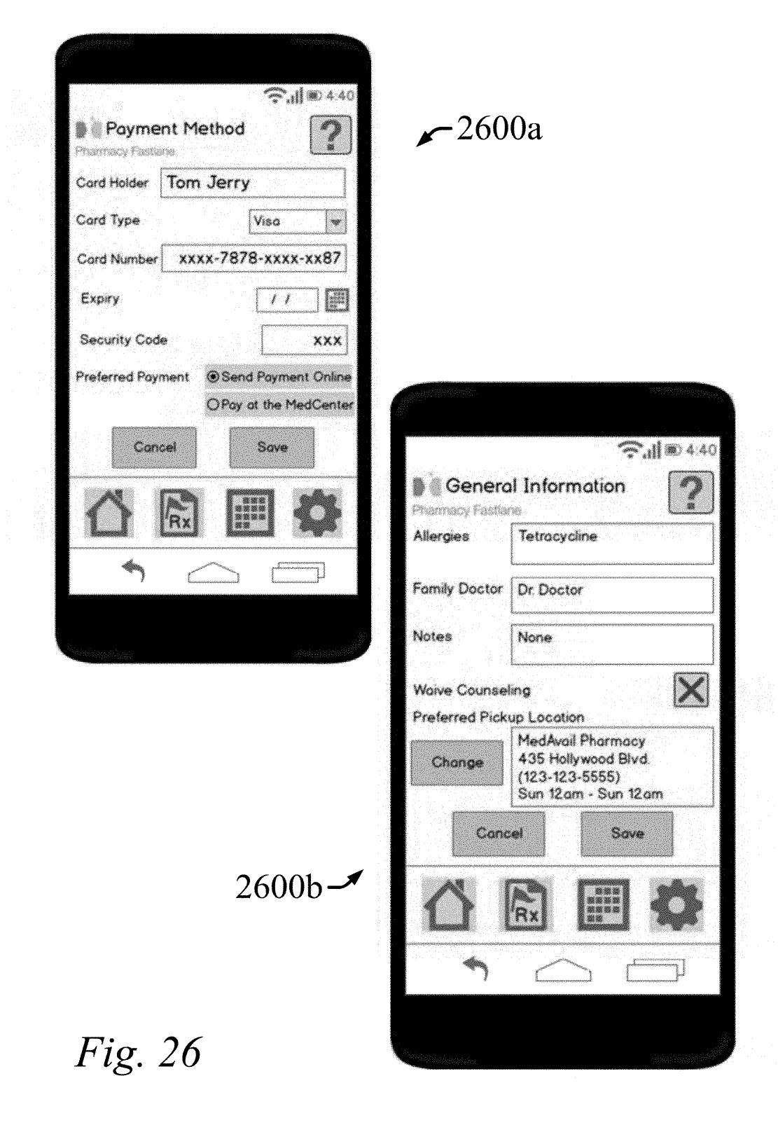

FIG. 26 shows a user interface at reference numeral 2600a for receiving information for the patient to pay for a filling a prescription, and a user interface at reference numeral 2600b for receiving drug pick up location and patient general information.

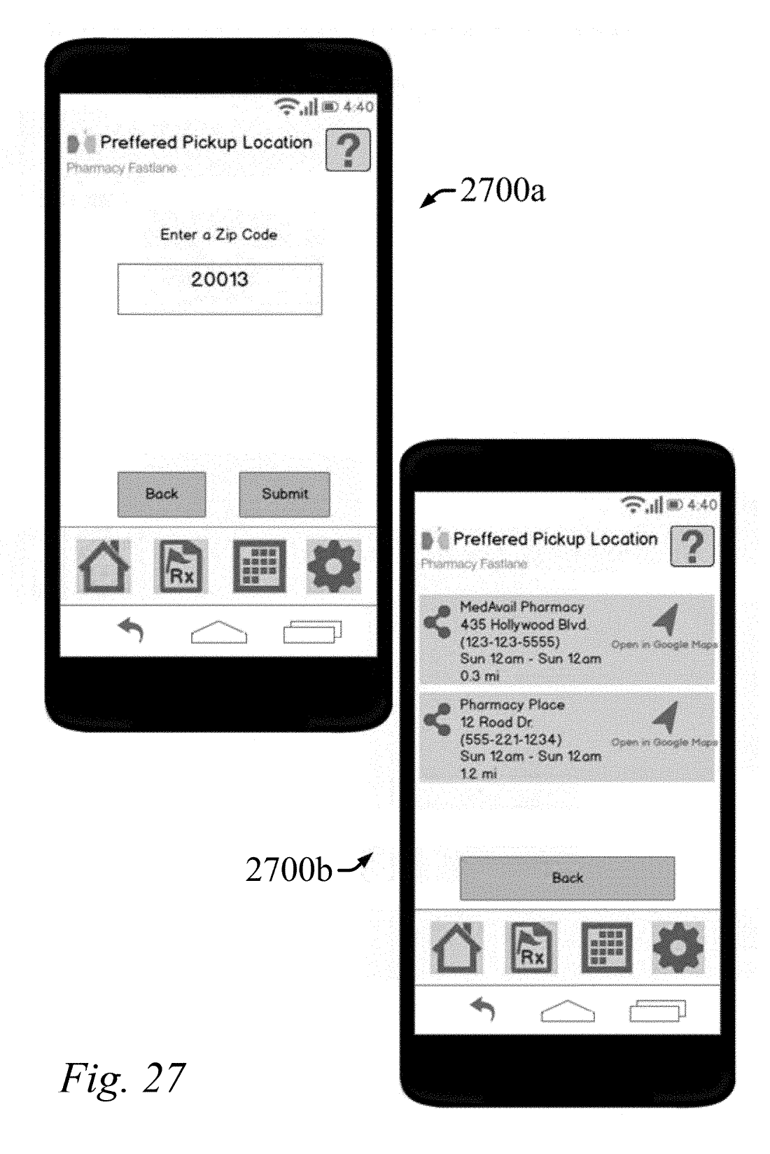

FIG. 27 shows a user interface at reference numeral 2700a for receiving information about where the filled prescription of the patient is to be picked up, and a user interface at reference numeral 2700b for displaying proximal locations corresponding to the input at reference numeral 2700a. By of example, and not by way of limitation, a map can also be rendered to display the proximal locations such as is depicted in FIG. 8.

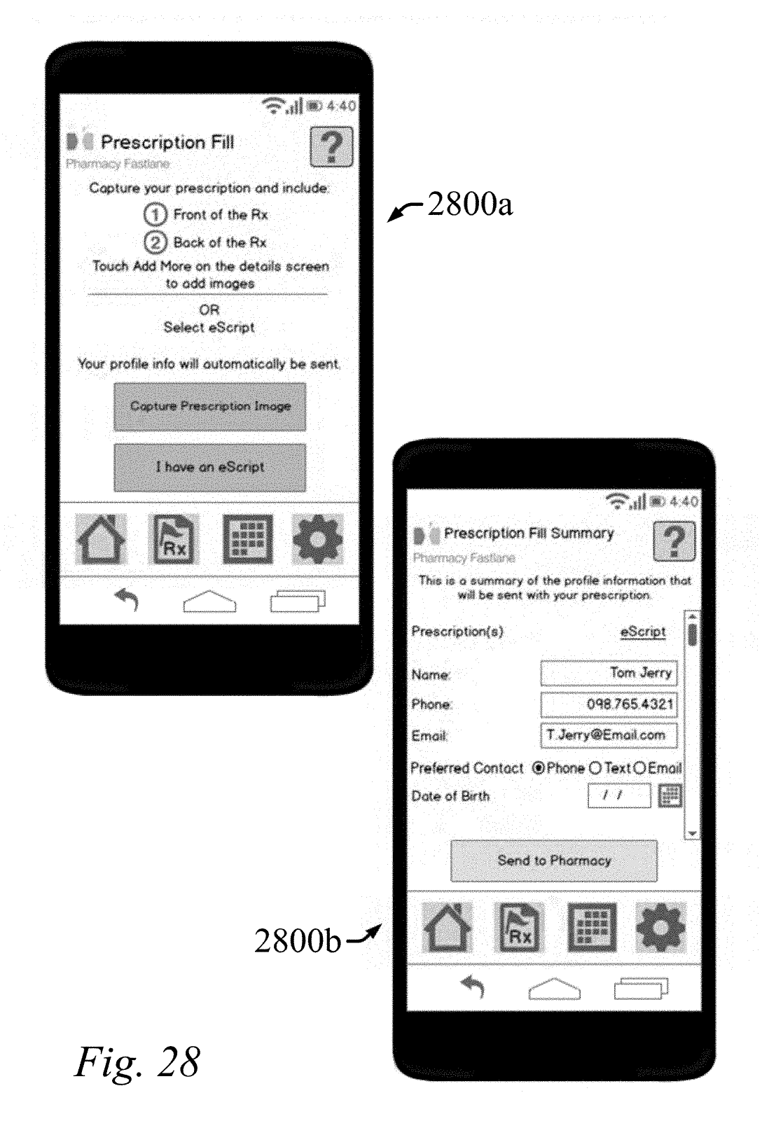

FIG. 28 shows a user interface at reference numeral 2800a for receiving one of two difference selections: (i) to capture an image of a paper prescription for a drug prescribed by a healthcare provider for a patient that is to be filled, or (ii) to acknowledge that an electronic prescription (eScript) for a drug prescribed by a healthcare provider for a patient has been received by the application and is to be transmitted by the application in order to be filled. The user interface at reference numeral 2800b depicts the displayed result of making the selection to fill an eScript, where the information to accompany the transmission by the application of the eScript can be input and/or can be retrieved from previously stored patient information. An icon labeled “Send to Pharmacy” can be activated by the user to initiate the transmission of the eScript and corresponding information for delivery over a network to a remote pharmacy. In response to receipt of the eScript and related information, the remote pharmacy will coordinate the filling and delivery of the prescription for pickup at a kiosk as described elsewhere herein.

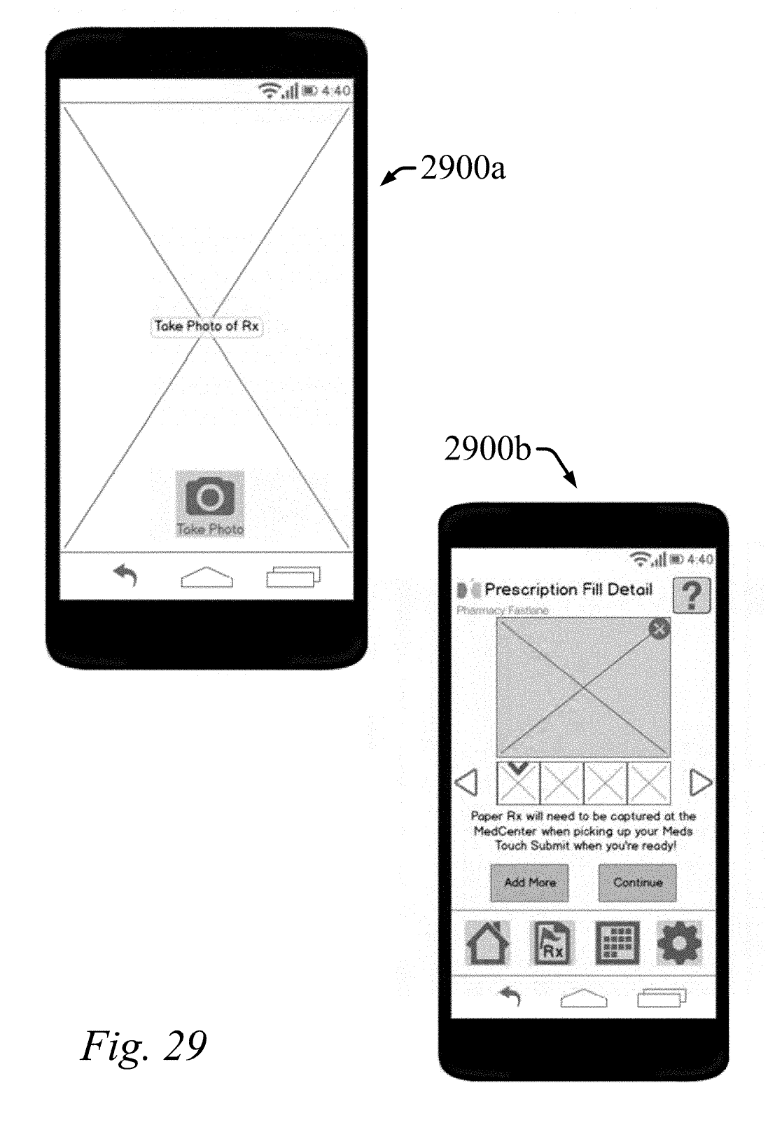

FIG. 29 shows a user interface at reference numerals 2900a and 2900b depicting the displayed result of making the selection shown at reference numeral 2800a in FIG. 28 to capture an image of a paper prescription for a drug prescribed by a healthcare provider for a patient that is to be filled. Note that the user uses the image capture device of the web enabled mobile computing device (e.g., the camera of a smart phone) to take pictures of the front and back sides of one or more paper prescription documents, each of which represents a prescription to be filed. Each captured image is rendered on the screen shot shown at reference numeral 2900b. In some situations, a diagnostic is displayed notifying the user that each paper prescription must be surrendered when the fill prescription is received, such as is shown at reference numeral 2900b.

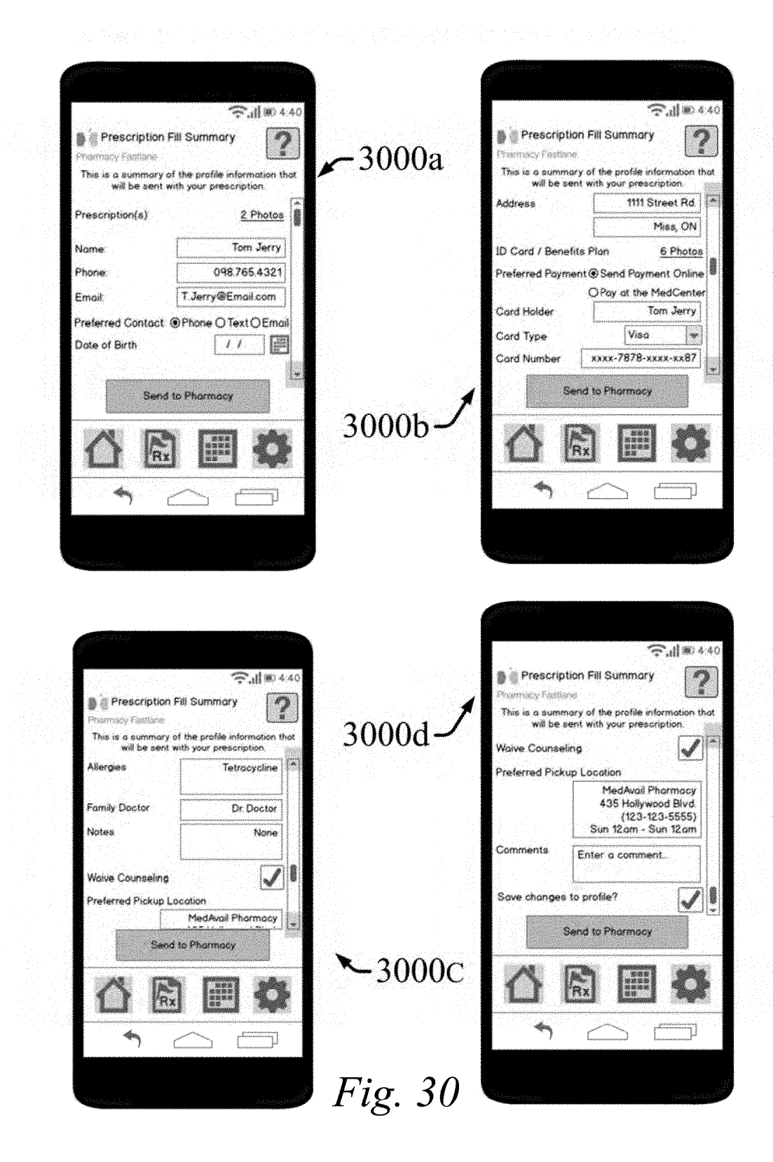

FIG. 30 shows respective user interfaces at reference numerals 3000a-3000d depicting the displayed result of input and/or retrieving previously input patient-related information that will be used in placing an order with a remote pharmacy for one or more prescriptions. Reference numerals 3000a-d show a continuous rendering of a display screen, the rendering of which can be changed by user activation of a slide bar icon on the right side of the user interface, where the rendering includes various information including patient contact, payment, and general information. Reference numeral 3000c shows patient allergies, physicians, a choice to receive or waive pharmacist counseling with respect to taking a prescription drug being ordered, and a selection of a location where the order of the one or more prescriptions is to be picked up.

Mobile Computing Device Application for Refilled Prescriptions Ordering

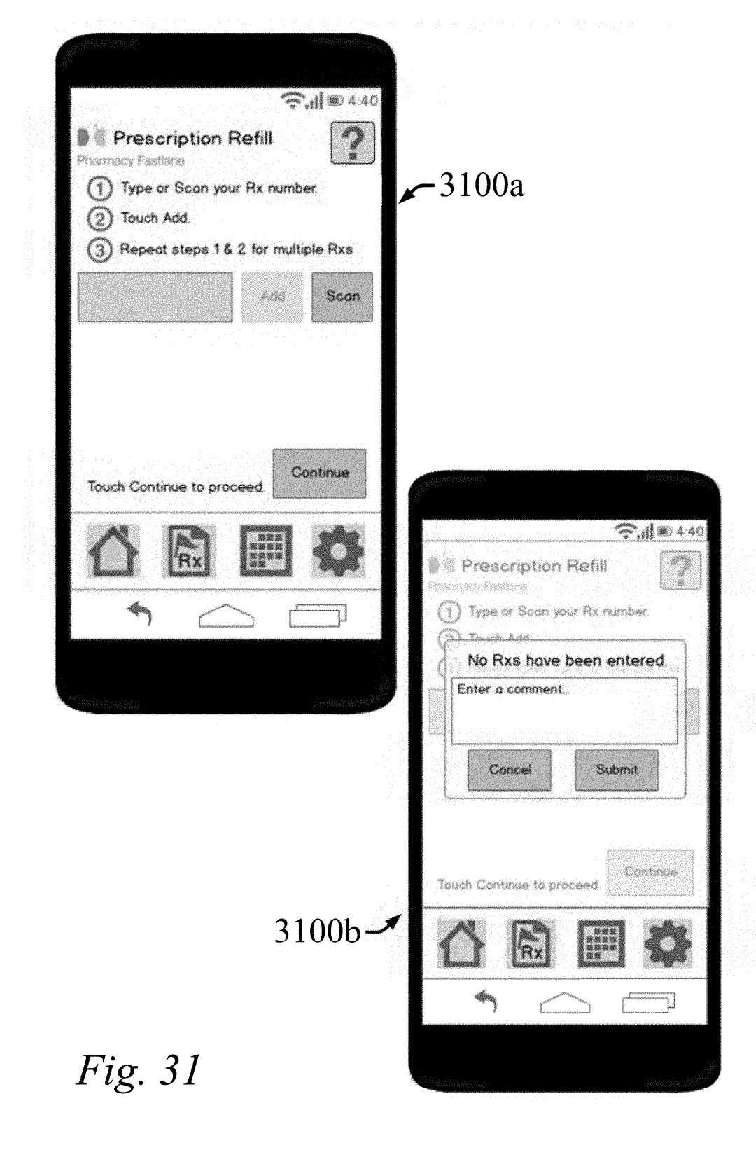

Referring now to FIGS. 31-35, FIG. 31 shows user interfaces at reference numerals 3100a-3100b for placing an order to refill previously filled prescriptions. The method by which the user selects each such prescription to refill can be to input as a prescription identifier as shown at reference numeral 3100a. As shown at reference numeral 3100b, the user can input a textual narrative, using a variety of words, phases, alpha-numeric codes, etc., that can be interpreted by a pharmacist, or agent thereof, to understand the particular prescription that is to be refilled.

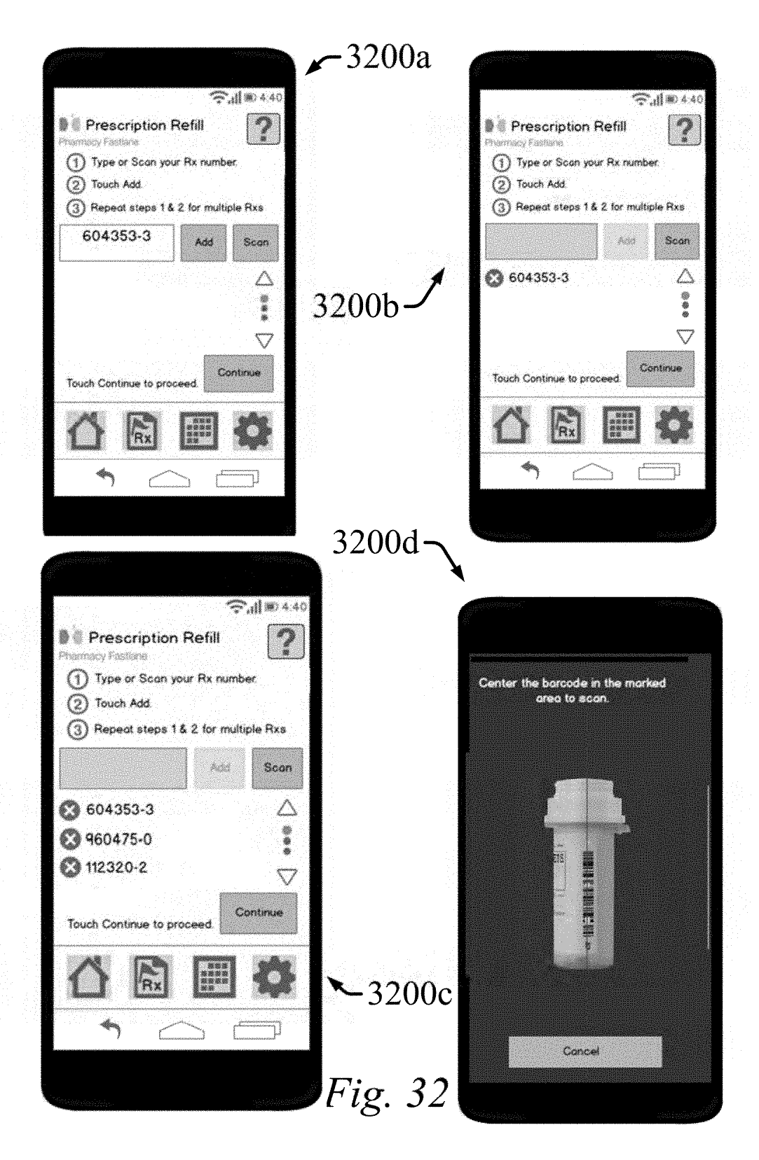

Referring to reference numerals 3100a in FIGS. 31 and 3200a-d in FIG. 32, each of three (3) prescription identifiers shown at reference numeral 3200c are input by a keyboard of the web enabled mobile computing device, or are captured by the image capture device and subjected to the application's optical character recognition capabilities as shown at reference numeral 3200d. The three (3) prescription identifiers, however input to the application, are then further prepared for transmission by way of a process that results in the placing of an order to refill the three (3) prescriptions.

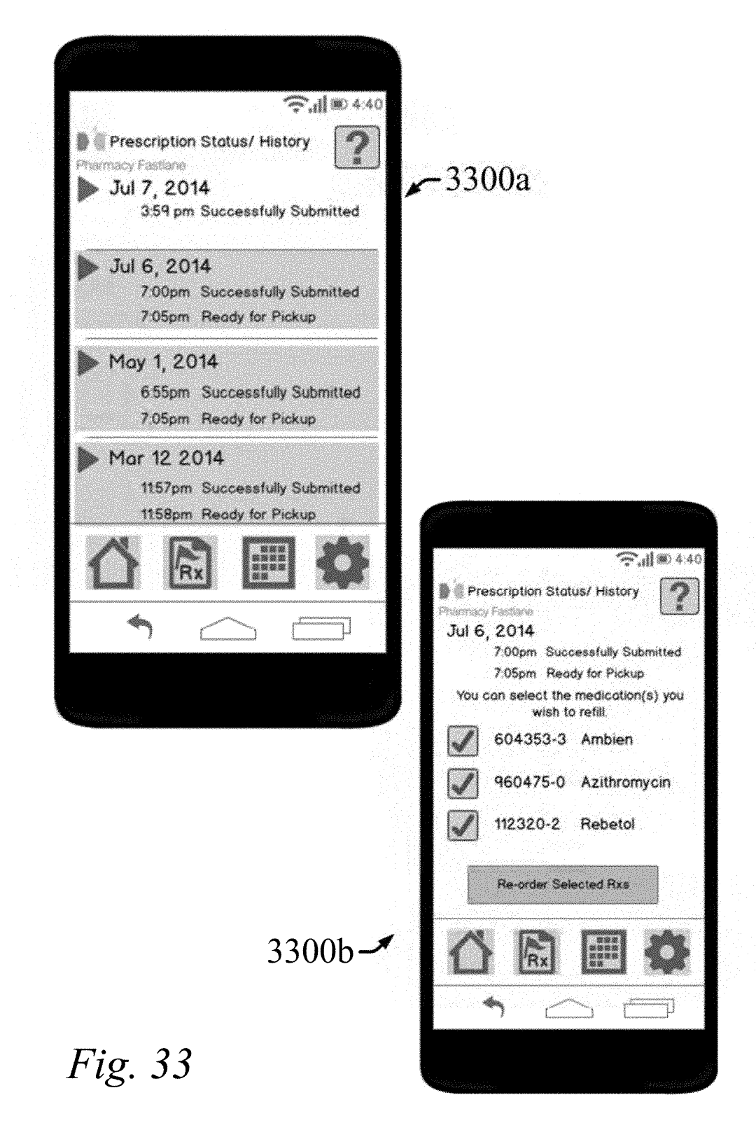

An alternative method for placing an order to refill the (3) prescriptions is shown in reference numerals 3300a-b in FIG. 33. Each of three (3) prescription identifiers shown at reference numeral 3300b are retrieved from an order in the list of prior order shown at reference numeral 3300a, where the particular order selected by the user included each of those three (3) prescriptions that had been previously sent by use of the application as the order to be filled.

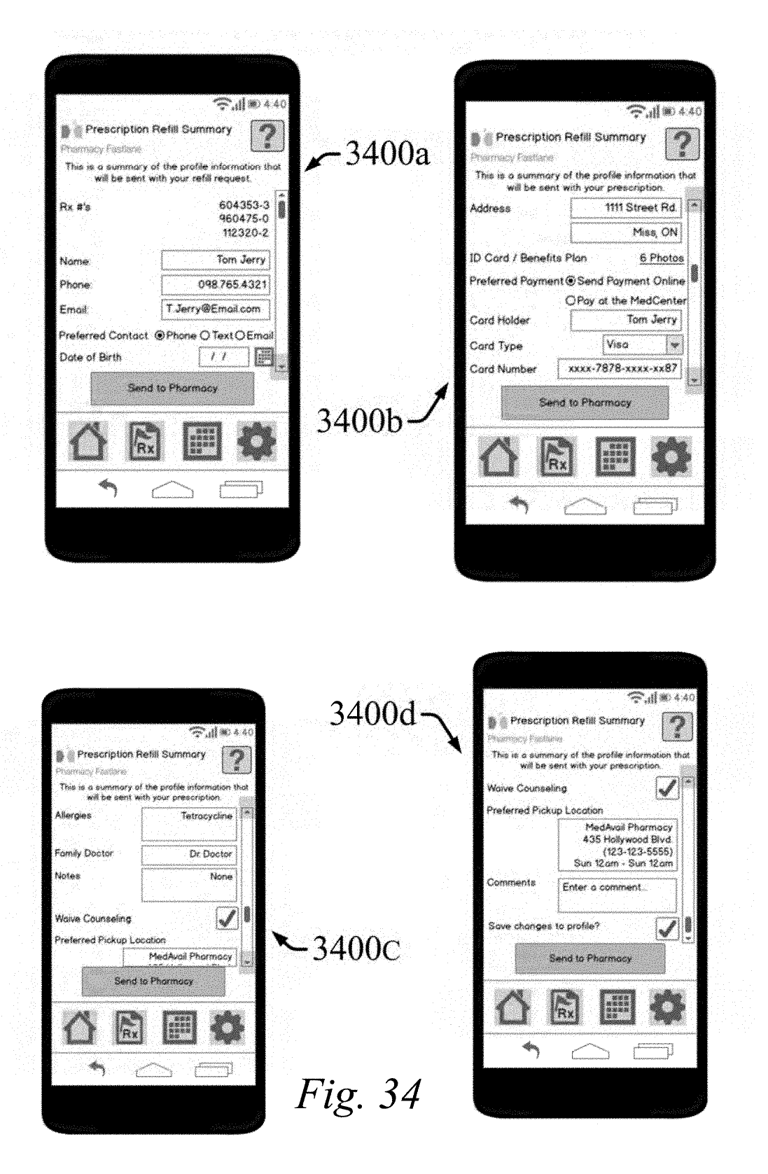

Regardless of the method employed by the user's use of the application so that the three prescriptions to be refilled have been input to the application, an order to refill the three (3) prescriptions can then be transmitted by activating the icon labeled “Re-order Selected Rxs” shown at reference numeral 3300b. Note, however, that additional information that is to be sent with the order can be input, changed, and/or reviewed by the user navigating to the user interfaces shown in FIG. 34 at reference numerals 3400a-3400d, each of which also shows the user activateable icon labeled “Re-order Selected Rxs”.

After the user has activated the icon to transmit an order of one or more new prescriptions, or an order of one or more prescriptions that are to be refilled, a diagnostic is displayed as shown at reference numeral 3500a in FIG. 5. The diagnostic rendering will display the success or failure of the order being placed by the application with the selected pharmacy at which the order is to be picked up. The inventory of drugs stored in the kiosk will changed to reserve drugs for which an order has been successfully received, thereby accounting for the remaining drugs in the kiosk's inventory that are not reserved and are still available to be ordered and dispensed from the kiosk.

In various implementations, the order will be dispensed from a kiosk having telepharmacy capabilities described here, which capabilities include video teleconferencing between the kiosk user and a remote pharmacist, labeling each new or refill prescription container in the order placed by the application, and dispensing the order from the kiosk to the kiosk user. Note that, in some implementation, the application executing on the web enabled mobile computing device includes video teleconferencing between the application user and a remote pharmacist prior to, during, and/or after the order is placed by the application user. As such, the time needed by the user to use the kiosk to pick up the order placed with the application is decreased for the benefit of subsequent kiosk users. Advantageously for further decreasing the time needed by the user to use the kiosk to pick up the order, the kiosk can perform parallel processing of picking the drug containers in the order from the kiosk inventory at the same time that the labels are being printed for each container that is picked in the order.

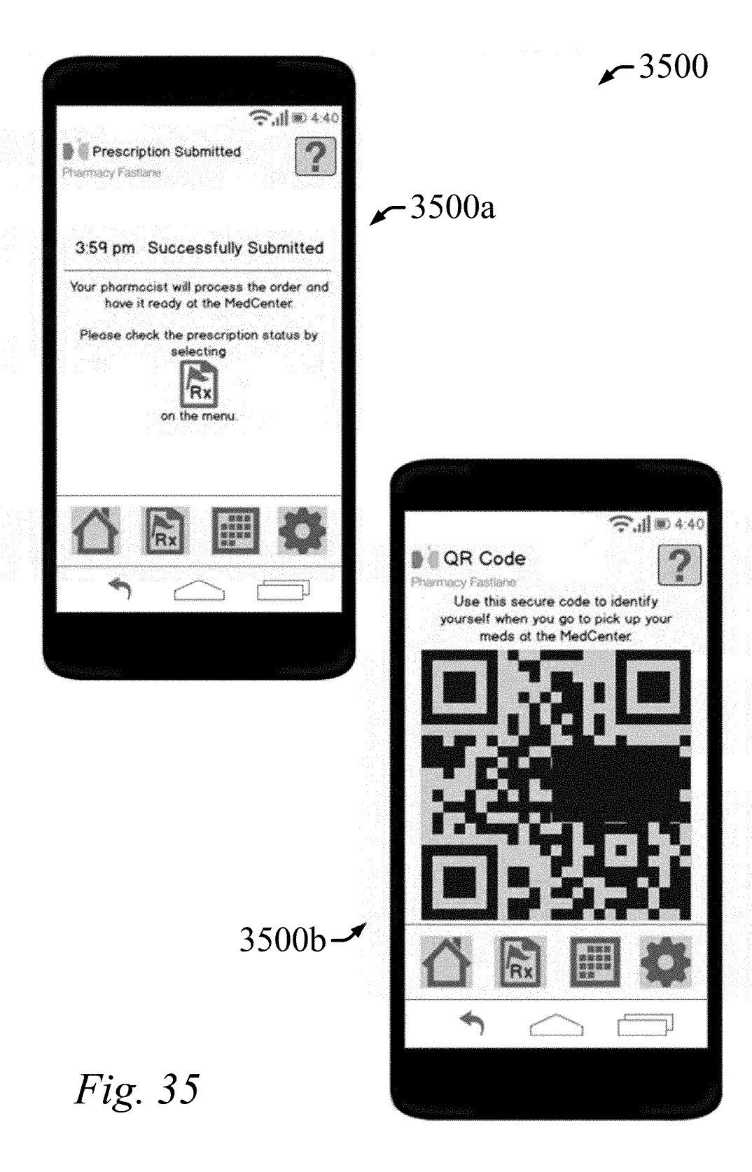

When the application user travels to the kiosk, as selected using the application, to pick up the order of new and/or refilled prescriptions, the application can be prompted to render a machine readable symbol such as is shown in reference numeral 3500a in FIG. 35 (e.g., QR code). The symbol can be rendered upon activation of one or more icon such as are shown at the bottom of the screen show in reference numeral 3500b in FIG. 35. An image of the symbol can be captured by the kiosk to identify the order previously placed by the user's use of the application. As such, the symbol can embed various information including, but not limited to, an order identifier and a patient identifier. When the order identified by the symbol has been authenticated for the kiosk at which the symbol is captured and read, then the kiosk will initiate the picking of each prescription container in the order from the kiosk's inventory that had been reserved for that order, and then placing a patient-specific label on each picked container. Preferably, a remotely located pharmacist, or agent thereof, will review the internal processing of all material aspects of the process of filling the order by the kiosk, and optionally counseling the patient at the kiosk via the kiosk's teleconferencing capabilities. The remotely located pharmacist will then use subjective and/or objective professional criteria to decide whether or not to initiate a signal that will be transmitted to the kiosk that will instruct the kiosk to: (i) dispense the order of prescription drugs from the kiosk to the kiosk user; or (ii) to move the labeled containers into an internal discard location of the kiosk and thereby refusing to dispense the order of prescription drugs from the kiosk to the kiosk user. As such, the pharmacist will have control and judgement over how, when, and to whom drugs are dispensed from the kiosk to the kiosk user. After the signal is received by the kiosk, memory will be adjusted to reflect to inventory in the kiosk that is available to be dispensed.

Prescription Drug Dispensing Kiosk

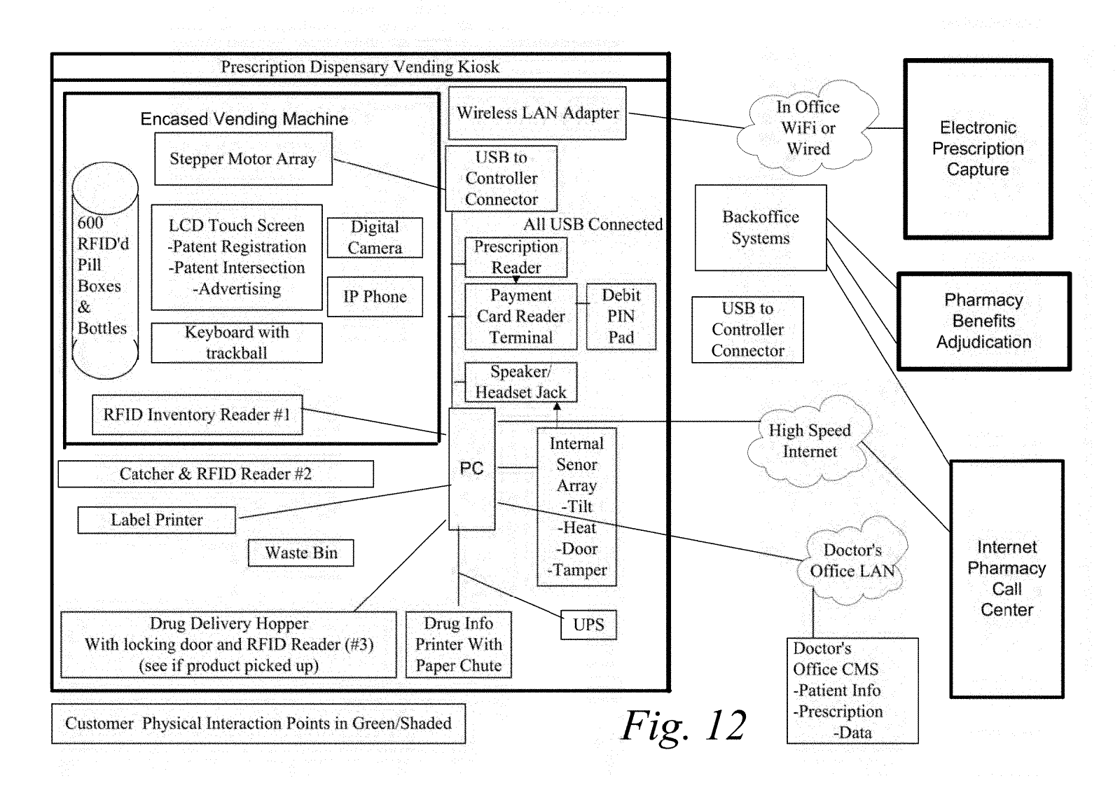

One particular implementation of Rx Dispensing Kiosk 110(z) shown in FIG. 1 is disclosed herein and illustrated in FIG. 12. This implementation, referred to as a vending kiosk, is a robotic prescription dispenser. The casing of the kiosk is preferably formed of steel having a nylon powder coating with sleek finish. Lighted LED band accents can be provided around each component, hereinafter described, to identify a variety of process steps. Hinges are preferably on the inside only, given that a secure body and foundation are required, and the base is preferably bolted to a concrete floor from four corners. Hardware devices should be mounted internally securely. Jacks located on the back provide for LAN, Wi-Fi and power. Application control software, by way of example, can be executed with an open source or proprietary operating system (e.g., Microsoft WINDOWS™) on hardware, such as a one or more Personal Computers (PC), and/or one or more Application Specific Integrated Circuit (ASIC) devices. The software can be custom designed applications and controller software with off-the-shelf driver software. Kiosk stepper motors are connected to the hardware via a USB microcontroller or a similar functioning design. A locking dispensing door mechanism can be included. There can be provided a prescription bar code reader that reads standard bar codes from printed prescriptions. Preferably, the reader can accommodate 8.5″×11″ inch sheets as well as smaller printed prescriptions. A payment terminal will allow for various methods of payment, including debit and credit cards.

In one implementation, the kiosk can include multiple RFID readers: one for product verification before labeling, one for inventory of the whole machine at once, and one for checking if product was collected from a bin. The catcher and RFID reader are arranged to catch the drug product, orient it, and then label it reliably. This system is generally required to support boxes and pill bottles. Similarly, a label printer must apply a label to both bottle and box reliably, and is preferably fault tolerant. A drug delivery hopper is ideally provided at a reasonable height to allow access for most users. Preferably there is a light inside. An RFID reader placed in the hopper determines if a product is not picked up by a user. The hopper is also subject to a lock, controllable from the software, and that is tamper resistant and sturdy. If the RFID read from a bottle does not equal the prescribed drug, then the drug container is moved to a waste bin for collection by servicing. The kiosk software will automatically issue the error to the call center, and an agent will decide to lock the machine and/or take over a session and speak to the consumer via telecommunications. It is generally required that the drug information printer print the drug information sheet from the adjudication database; and that the printer itself be sturdy, and notify the software of ink status, jam and paper out conditions required. The printer is preferably mounted securely, and has a relatively large paper capacity (e.g., at least 500 sheets). A 15″ or 17″ touch screen is provided, for example, for the input, allowing a large text size and potential advertising space. A keyboard is also provided with a trackball for further input.

A camera is provided for security and for call center interaction. Similarly, an internet-protocol phone is provided for call center interaction, facilitating the system for blind patients. Alternatively, a speech output device may be implemented for instructing the patients via computer-generated voice. An Uninterruptible Power Supply (UPS) provides for an orderly and chronologically proper shutdown in the event of a power failure, such as sufficient to complete a current transaction for a current user of the kiosk. A speaker and headset jack will be controlled by the kiosk application software. If the headset is connected then the speaker is off, and vice versa. A wireless LAN adapter is preferably provided to connect to the doctor's handheld and maybe office LAN. Cable connectors on the back of the machine include the power cord for the unit (e.g., need one cord out from UPS and internal power bar or UPS multiple plugs). A network cable female jack is provided connecting to high-speed internet service. A network cable female jack is provided for LAN connection to the doctor's office, or handheld etc. Further, a male coaxial cable jack is provided for an antenna for Wi-Fi transceiver.

In a particular implementation of an implementation disclosed herein, the kiosk incorporates biometrics technology for authenticating the identity of a user of the kiosk. In another implementation disclosed herein, a system (including the kiosk) incorporates triage functionality that enables a user to be streamlined prior to a visit with a doctor. In a particular implementation disclosed herein, the kiosk is linked to a clinic management system that incorporates triage functionality. The kiosk doubles as a gateway for accessing medical services provided through the clinic in a more efficient way. The patient benefits by ensuing that s/he accesses the most appropriate medical services given his/her problem. The medical system overall benefits from more efficient allocation of available resources, based on the triage related considerations.

Another aspect disclosed herein integrates with a portable medical record to provide an economic model for financing improved electronic access to medical information, and improved technology tools for providing medical services.

According to another implementation disclosed herein, a collection of technologies allows a doctor to create a prescription for a patient which can be used at a secure kiosk to dispense medication automatically.

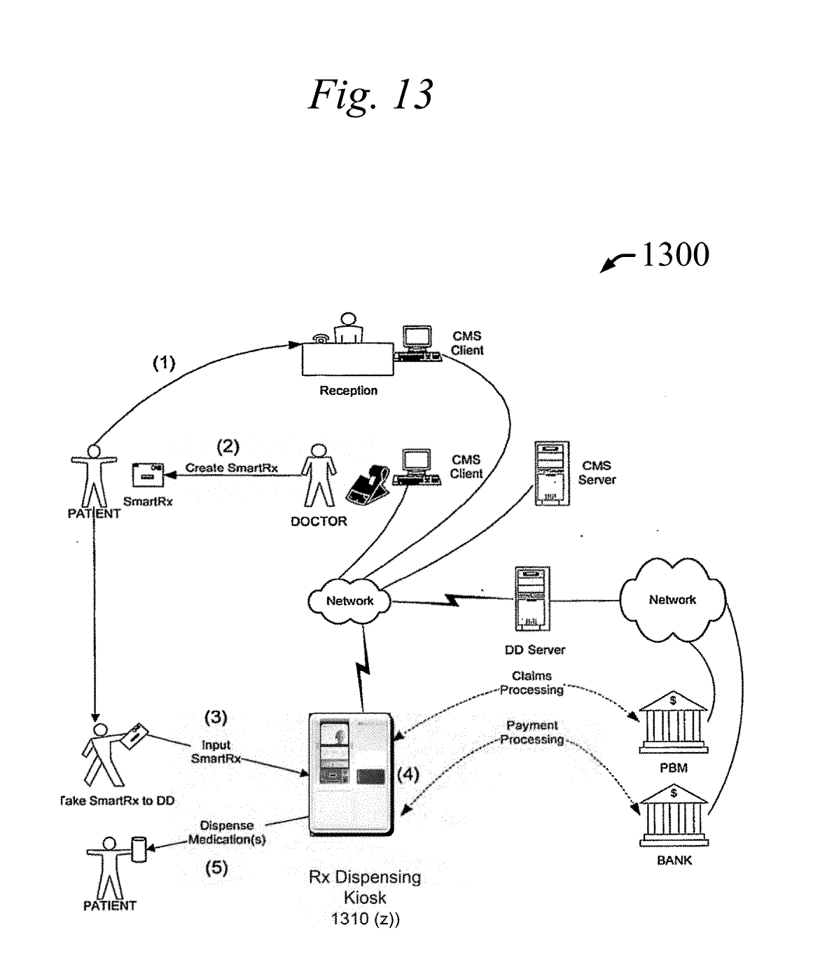

As illustrated conceptually in FIG. 13 at reference numeral 1300, a system enables a method that includes the following steps: (i) A patient provides drug plan information to a clinic's administrative staff before an appointment with their doctor; (ii) In the appointment, the doctor creates a prescription script for the patient; (iii) The patient inputs a credit card and the prescription script into a kiosk;(iv) The kiosk processes the claim and payment via an on-site server; and (v) the kiosk dispenses the medication(s) to patient. Each of these aspects disclosed herein is discussed more fully below.

1. Acquisition of Patient Drug Plan Information

The clinic's administrative staff collects or confirms the patient's drug plan information. To do this, the patient, who is already profiled in a Clinic Management System (CMS), checks in at clinic front desk for their doctor's appointment. The administrative staff queries the patient for drug plan information. A pamphlet or website should be provided to assist the administrative staff in capturing the correct drug plan information for the patient. A drug plan may assign unique ID numbers for each member of a family. The status of the drug plan number is then validated. The patient will be informed by the administrative staff if the drug plan is expired. This is done at this time since it can only be corrected at this point in time.

2. Creation of the Prescription

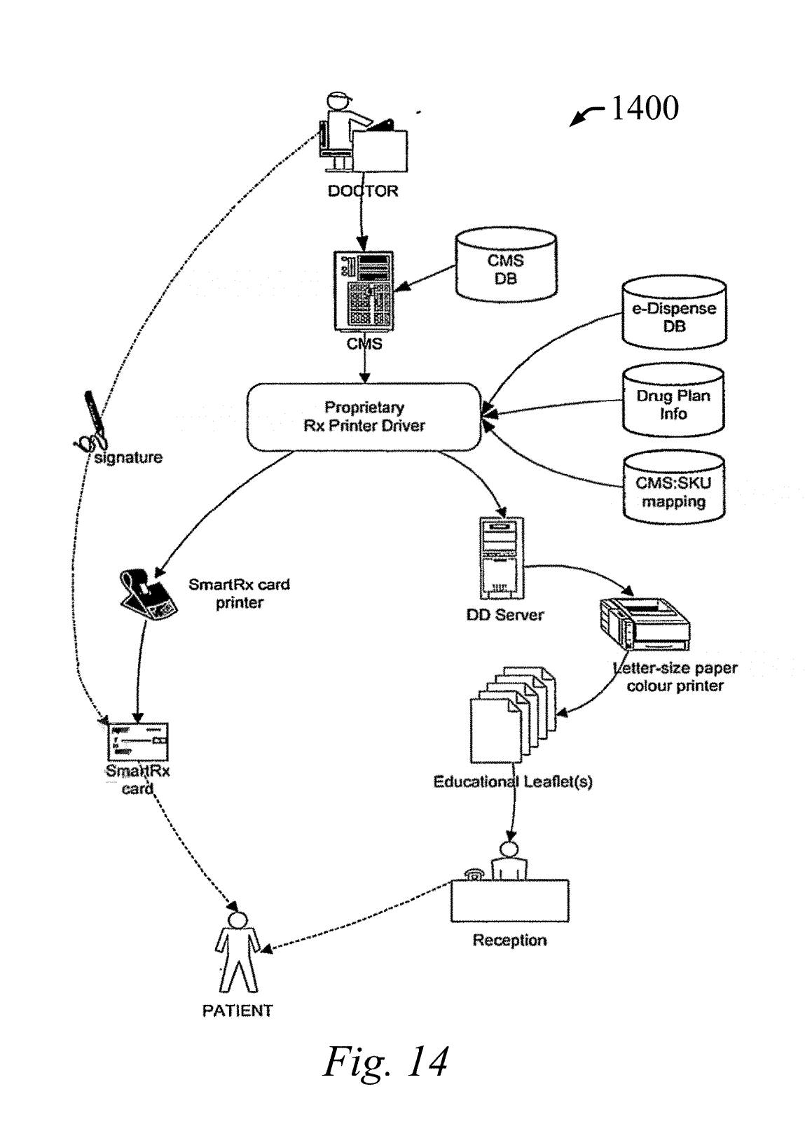

As illustrated in FIG. 14 at reference numeral 1400, the doctor prescribes medication by creating a prescription and giving a paper or electronic version of the prescription to the patient. To do this, the patient goes to the doctor for the appointment and the doctor makes a diagnosis and selects a particular medication(s) to prescribe. The doctor uses the CMS to enter the prescription and prints it.

Preferably, stock keeping units (“SKU”) for the prescription to be dispensed will be pre-determined. Generally, a doctor will create a prescription (that can be used at the machine) only if the data in the prescription matches (or partially matches) an entry in the CMS SKU mapping. What needs to be determined is if there is an appropriate SKU in the kiosk that could be used for either: (i) a complete first filling of the prescription; or (ii) a partial filling of the prescription. This is because each of the SKUs are preferably pre-filled to a specific amount. The theoretical balance of the prescription needs to be calculated, based on the initial SKU to dispense, and encoded onto the prescription as well, the balance with either: (i) number of refills/repeats, or (ii) completion of a partial filling, or (iii) a combination of both. This balance needs to be communicated to the Mail Order system when the prescription is filled.

A proprietary printer driver (otherwise referred to as an “Rx printer module”) installed on the CMS scans the printout data to determine the nature of the print job. The Rx printer module can be either a peripheral of the CMS, or a shared network printer. A prescription, when detected, invokes the creation of the prescription. Otherwise, non-prescription data is passed through to the default specified printer. It should be understood that particular implementations disclosed herein integrate with the CMS such that the CMS and its resources support the operation of the system described herein.

The Rx printer module checks the existence and availability of each medication in the server database. Medications not available in the system are passed through to the default specified printer. For each medication in the prescription, the Rx printer module prints a prescription to the prescription card printer with two data components: (i) human readable Rx (printed in black ink) with all data elements required for any pharmacist to dispense the medication; and (ii) machine readable ‘token’. This token represents all the prescriptions that have been prescribed by the doctor to the patient. This means that the prescription is preferably large enough to contain the details of all medications prescribed. This could be up to three (3) prescriptions on the full prescription, for example.

The Rx printer module also creates a print job on the server, to print any necessary educational materials (e.g., on a local printer) pertaining to the medication (e.g., one page per medication) to a local printer on standard size paper. This printer is a peripheral of the local server, and accessible by the clinic support staff. The doctor signs the prescription and gives it to patient. The doctor also counsels the patient about the medication and its usage, telling the patient that they can pick up educational materials specifically about that medication from the staff at the front desk. The doctor also explains that the prescription can be used at a kiosk located nearby and that the staff can assist them should they wish to use it and need assistance. The doctor makes it clear that the prescription is also operable to fill the prescription at a traditional pharmacy.

3. Using a Kiosk to Dispense Prescription Medication

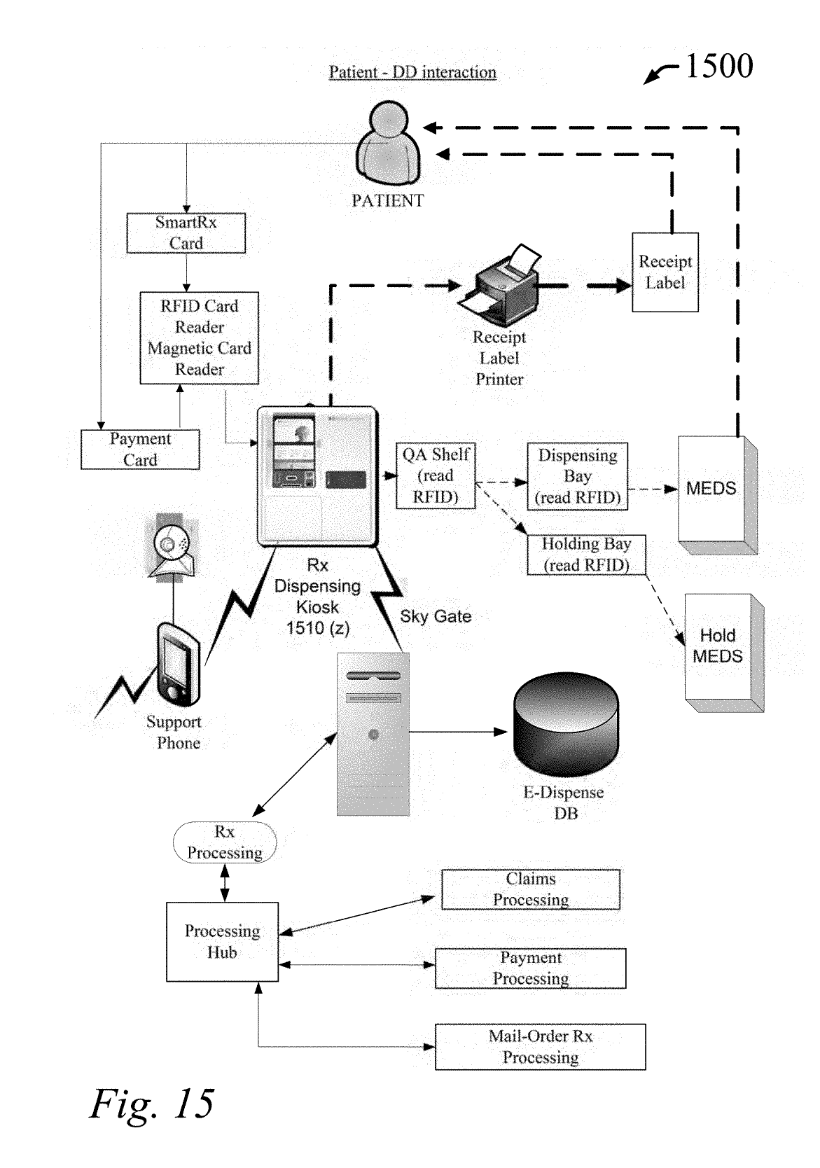

The patient interacts with the kiosk to get their medication, as illustrated by the exemplary system depicted in FIG. 15 at reference numeral 1500. The prescription is paid for by a drug plan, debit or credit card, or any combination. The patient receives the medication and instructions. It should be understood that the patient may obtain one or more prescriptions per visit.

In particular, a patient takes their prescription to a kiosk. The kiosk screen prompts for the credit card to begin a transaction. The kiosk features a user interface that is easy to interpret and easy to use. The patient inserts their credit card (for example), and the credit card is read and validated by machine. The patient is prompted to retrieve the credit card, and takes back the card. The kiosk screen prompts the patient to insert the Prescription next. The patient feeds in the paper prescription, and it is read by the machine. At this point, the information from the credit/debit card, drug benefits card and the prescription have been retained.

The kiosk processes the prescription data and displays that it is processing. During processing, the prescription data is decrypted and verified to ensure that it has not been tampered with. There is also a check to ensure that the prescription has not been already filled. If it has, then a notification is sent and the prescription is rejected. This is operable by virtue of the fact that the data elements associated with the prescription include unique data elements.

The system interfaces with a server to adjudicate an insurance claim, if any, and determines the amount payable by the patient. The transaction is preferably transacted via a proxy to the server.

The kiosk screen displays the amount payable, and the patient is prompted to accept or cancel the transaction. If the patient accepts the transaction, the system interfaces with server to transact the payment. The transaction is completed with the relevant financial institution. This transaction is transacted via a proxy to the server.

The kiosk screen displays that the payment has been approved. The kiosk pushes the relevant medication off the shelf and onto a “QA Shelf”. The reads a radio-frequency identification (“RFID”) tag on the medication on the “QA Shelf” to confirm that the medication dispensed is the medication on the prescription. The system confirms that the medication is correct and drops it into a dispensing bay at the bottom of the kiosk. The system then “eats” the prescription paper ticket, retaining it in a lock box similar to a cash box. The system updates inventory to reflect that the particular medication has been dispensed.

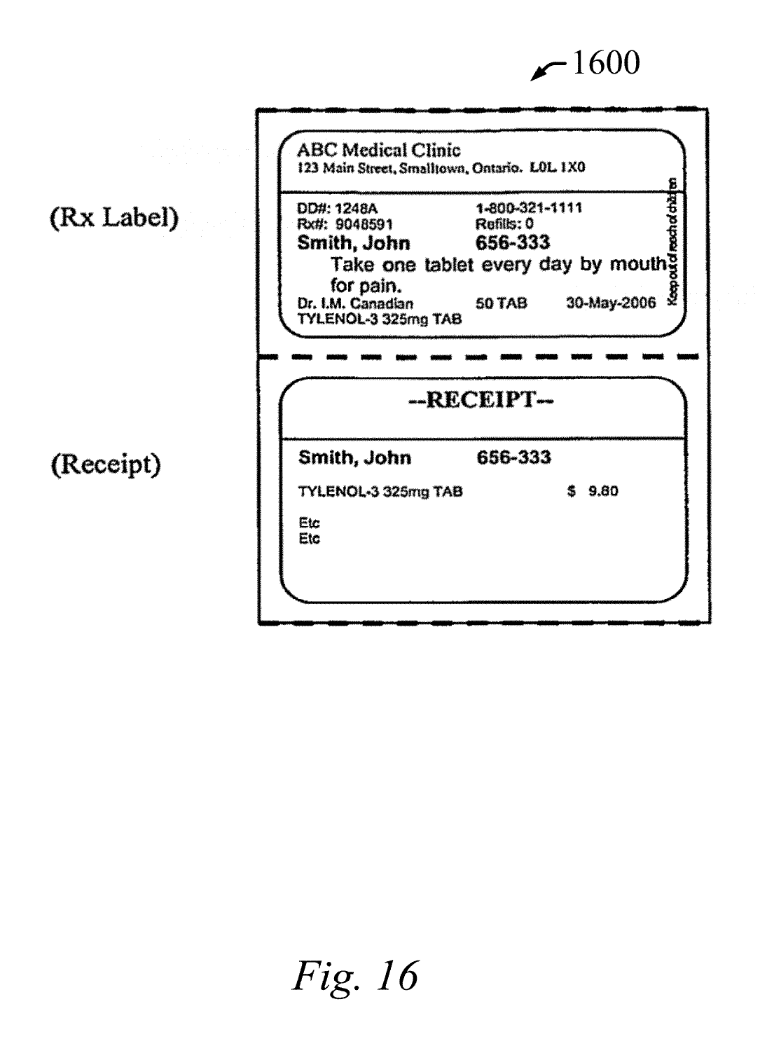

Preferably, the kiosk system also prints a combination prescription label and receipt, an example of which is illustrated in FIG. 16 at reference numeral 1600. The kiosk system then unlocks a dispensary door, and the kiosk screen advises the patient to retrieve the medication. The kiosk system flashes light in (or near) the dispensary bay and makes an audible sound in (or near) the dispensary bay to retrieve the medication. The kiosk system confirms that the medication is dispensed by sensing the RFID from the bottle is gone. The kiosk system locks the dispensary door, and updates the database to reflect successful pickup. The kiosk system advises the patient to affix the label to the medication container. The kiosk system also advises the patient to pick up educational material from the reception desk if they have not already done so.

Note that if the patient leaves the medication or receipt in the Kiosk, within 30 seconds of the medication dropping into the machine bottom, a reminder beep/sound and a reminder to the patient to retrieve the medication is displayed. If the patient does not retrieve the medication, this is repeated, or the kiosk system re-locks the dispensary door and sounds an alarm or otherwise signals for attention from a staff member. The medication is put aside for the patient. The patient is contacted and arrangements made to ensure that medications are provided to the patient.

In the event that a payment is declined by the financial institution, the message “transaction declined” is displayed to the patient. The prescription is returned to the user, and a “Declined” receipt is printed.

If the transaction is cancelled by the patient after seeing the amount payable, the message “transaction cancelled” is displayed to the patient, and the Prescription is returned to the user.

If the patient goes to pick up their educational materials printout but it did not print or it is missing, then a clinic staff member opens an admin interface, selects ‘Reprint Education Material by RX#’, enters the RX# from Prescription or from container (if they have already been to machine), and provides the printout to the patient.

If the QA Shelf detects an incorrect container, i.e. the QA shelf reader detects an RFID it was not expecting, then it kicks the container into a holding/reject bin. The message “internal dispensing error” is displayed to the patient, and staff will be notified.

In a particular aspect of the present information, the kiosk disclosed herein is operable to obtain specific and up to date information regarding a particular drug, while maintaining the privacy of the patient.

4. Critical Failure Scenarios

In the event that a medication is placed in a container where the label does not match the medication, this will be interpreted as an error that occurs at either distribution center or the manufacturer. Note that this may invoke a broadcast for a product recall for that medication.

In the event that there is a kiosk stocking error, e.g., the medication was placed on the wrong shelf/row, the RFID reader on the “QA Shelf” will detect this error when the machine attempts to dispense the container. If a CMS medication to Kiosk SKU mapping is incorrect, this is attributable to human error since the mapping table should be created, reviewed, and scrutinized by multiple people. Each machine in the field may have a slightly different mapping of drugs.

There could be data corruption on the RFID tag. Any data errors found should be rejected. The data on the RFID should have a checksum to ensure that this is not the case. A dead RFID will not produce any reading, possibly causing multiple dispensing.

In the event of a kiosk hardware error, e.g., incorrect shelf/row item dispensed, the RFID reader on the “QA Shelf” will detect this error when the machine attempts to dispense the medication container.

If no item is dispensed (e.g., item is stuck somewhere in the machine, or an item is dispensed but the RFID is dead or unreadable), then the RFID reader on the “QA Shelf” will detect this error.

If multiple items are dispensed, the RFID reader on the “QA Shelf” will detect this error, and preferably kick all the items into the reject bin.

If a power failure occurs during a transaction, the Kiosk will preferably cancel the transaction. If a payment has been made but the medication has not been picked up, the transaction should be cancelled. If the power failure occurs while the labels are printed, the transaction should be reverted the next time power is restored. If the labels have been printed, the prescription educational material has been printed and the medication is in the hopper at the bottom, then the door should be unlocked to allow the patient to retrieve the medication.

A power failure can occur at any time during a transaction. In this event, notifications are sent immediately to clinic staff and the server if the internet is available. If the transaction has been completed, the funds being debited from the financial institution but before the medication has been retrieved by the patient, then the transaction will be queued to be reversed the next time power to the Kiosk has been restored. The Kiosk will refuse to accept any more transactions until power has been restored. The Kiosk monitors the internal temperature of Kiosk even with the power off Each medication will have a temperature range that the medication should be stored at. The medication should not be dispensed if the medication has been outside the specified storage temperature range. These and related internal conditions are monitored by operation of the Kiosk and medication that has been stored outside of normal parameters and/or expired will be rejected by the Kiosk for disposal.

5. Technical Considerations

Listed below are exemplary prescription data.

| Requirement | Max size (bytes) |
|---|---|
| medication name | 51 |
| medication ID | 20 |
| dosage | 13 |
| frequency | 13 |
| repeats | 1 |
| quantity | 2 |
| duration | 13 |
| start date | 4 |
| notes | 100 |
| physician name | 51 |
| physician phone number | 10 |
| physician address | 141 |
| patient name | 51 |
| patient phone number | 10 |
| patient age | 2 |
| patient weight | 2 |
| insurance carrier id | 4 |
| drug plan no. | 20 |

The prescription label is designed such that it is easy to match up to the container to which it needs to be affixed. In one particular implementation, a drug name in large lettering is placed at the top of the label, and then the same corresponding drug name in large lettering is placed on the container inside a ‘dashed line area’ that says AFFIX HERE.

The prescription ID will be unique. It will be defined preferably as: CCCCCDDDYYYYMMDDXXXXX, where: CCCCC is the clinic id; DD is the doctor issuing the prescription; YYYY is the year of issue; MM is the month of issue; DD is the day of issue; XXXXX is the prescription number for the day issued by that doctor.

The receipt will preferably contain all the information that is required for it to be valid for income tax purposes, or to accord with other laws.

The generic drug educational information for use in the kiosk system could be sourced from different vendors. The educational material preferably should fit on one letter-size sheet of paper. That is, one sheet per medication.

For use with the kiosk system, all credit cards or debit cards conform to the physical dimensions as specified by the ISO-I standard size (85×54×0.8 mm). Preferably the processing will be done directly with a bank rather than through third party processing. “Track 1” and “Track 2” shall be read from the cards, and the data passed to the local Kiosk Server in a message bundle for processing, in a manner that is known.

For the debit cards, the keypad will preferably be secure. A debit keypad can only be used in circumstances where the transaction can be monitored by a live person. If any tampering is detected, the Kiosk scrubs the transaction. All PIN data must be in volatile memory. It must never be stored or committed to permanent storage.

A Prescription will contain a prescription ID that identifies the prescription. The drive mechanism for accepting the Prescription is essentially the same as that of the credit/debit card. This assumes that the Rx card has the same dimensions as the credit/debit card. If the thickness of the Rx card is out of spec in relation to the debit/credit card, a special reader can be used. To prevent old Prescription's (such as those used previously at a regular pharmacy) from being used, they will have a discrete lifetime that they are accepted, e.g., one week, or the server and database are configured to track a prescription is filled so that the same prescription is not filled twice.

The kiosk system preferably has one reader, but treated as two logical readers: (i) one for the Prescription, because the Rx reader needs to be able to return the Rx if the transaction is cancelled and also needs to be able to retain the Rx once the transaction is completed; and (ii) a magnetic strip reader for the payment card (credit/debit). The reader needs to be able to read the magnetic strip on credit cards and be able to read the Prescription. The reader is required to consume the Prescription card and place it within an adapted cash box. This cash box shall be exchanged with an empty cash box upon stocking.

The Prescription printer will print both a human readable prescription and a machine readable prescription ID. The printer used to print the educational materials for distribution to the patient is preferably a color printer that is a peripheral of the Kiosk server. The receipt/label printer in the kiosk is an impact printer. Replacing the ribbon will be based on the number of prescriptions dispensed. Each time the machine is filled, a test print of the label and receipt printer will be done. This will allow the technician to decide to replace the ribbon immediately or postpone the replacement until a future visit. The ink is black only.

The display can be a 12-17″ touch panel display. The touch panel will have a touch panel driver that emulates a mouse. The touch screen portion will connect to the system in the kiosk system cabinet via USB. The touch screen will be supplemented with two buttons that correspond to proceed and cancel. The buttons will be labeled as such in both in English/French, and also possibly in Braille, or other languages.

Each of the kiosk system units will have an on board sound card. Standard drivers will be used. In order to communicate with the call-center pharmacist the patient will have to pick up the handset to initiate a call. The software will capture and translate a VOIP connection to the call center pharmacist. A non-irritating tone is preferably used to convey alerts or to gain the user's attention.

The first keypad, in one particular implementation, has two physical buttons spaced out evenly along the right bottom of the display. A laminate overlay, fitting over the buttons and screen, can be used for any necessary physical labeling.

Markings on components throughout the system require consistency for easy identification and QA purposes.

A common identifier, used whenever possible, shall be the medication SKU. The digits 0-9 will be assigned a unique color. The color-coded SKU shall preferably be identified on: (i) drug container labels (manufacturing line); (ii) internal packaging (the smaller boxes containing unique SKUs that go inside the larger shipping packaging); (iii) row labels at the front of each shelf inside the kiosk; and (iv) the ‘flipper’ on the end of each coil inside the kiosk.

Non-color-coded SKU should still be identified where color is not available, such as: (i) the prescription label; and (ii) the receipt label. For the medication containers, there is a need to standardize to a minimal number of container sizes as this affects the shelf and coil design in the kiosk. The ideal container characteristics are based on the tray and spiral combination. These dimensions allow for the product to tilt slightly backwards against the upper edge radius of the coil (2″ diameter coil) for perfect dispensing (i.e. no ‘crabbing’ of the container along the bottom of the shelf):
1. WIDTH: 2.95 inches (˜2 15/16″) maximum (required to fit between 3.0-inch sidetracks). Approximately 7.4 cm.
2. DEPTH: 1.35 inches (1 11/32″) maximum allows 12 items per coil (our goal), and 1.5 inches (1½″) maximum allows for 10 items per coil if necessary for atypical packaging. Approximately 3.3 cm and 3.7 cm, respectively.
3. HEIGHT: 3.75 inches (1¾″) maximum allows a sufficient number of shelves to fit in the machine. Taller containers may be allowed for atypical packaging by giving one shelf (probably the top shelf) more headroom. Upwards of 4.1 inches (4 1/16″) is preferable.
4. VOLUME: ideal is approximately 125 ml (cc). The size needs to allow for cotton.
5. SHAPE: ideal is rectangular or oval with slightly rounded bottom (to prevent ‘crabbing’) with a wide-mouth opening.
6. CAP: cap must be tamper-evident and child-resistant.
7. COLOR: translucent (clear or near-clear).
8. MATERIAL: PET (if clear is a requirement) or HDPE (if opaque is okay and if cost is better).

The pill bottle form factor will be preferably be a 125 ml PET clear wide mouth bottle. The dimensions of this bottle are similar to the bottle above with a wide mouth. The RFID tag could be contained on the label that is applied to this bottle when it is filled and packaged. For atypical (non-pill) items such as powders, blister-packed drugs, liquids, inhalers, etc. formed plastic clamshells can be used that have a footprint no larger than those required for the pill containers (WIDTH×DEPTH). HEIGHT may need to be slightly taller.

Patients may need phone access to a pharmacist for customer support. Maintenance personnel also need phone access to the relevant service provider. This is preferably a mobile phone with a telephone booth quality handset. Internal direct-dial (to a fixed number) cell phone inside the machine, e.g., the fixed number is the service provider, which will transfer calls as needed.

In a number of situations, the physical inventory in the kiosk and the electronic inventory (as tracked by an automated inventory tracking means, referred to as “e-Dispense”) will need to be reconciled. Foremost, this needs to be done when a kiosk is re-stocked (fulfillment of the purchase order generated by e-Dispense). In the ideal success scenario, the shipment manifest (a.k.a. bill of lading (“BOL”)) will be the same as the e-Dispense Purchase Order (“PO”) (both physically and electronically). Non-ideal scenarios include: (i) the PO differs from BOL (intentional, e.g., stock unavailable, etc.); (ii) the BOL differs from physical shipment (unintentional); (iii) the BOL matches the physical shipment but shipment is damaged.

When stocking of a kiosk is complete, the e-Dispense inventory database must be reconciled with what is now in the machine. A few different methods are contemplated for implementations in connection:
1. The stocker uses a handset to call the service provider's office and initiates an “Inventory Update” request to modify thee-Dispense inventory to the new numbers.
2. The stocker uses the display and keypad on the kiosk to modify the initial e-Dispense PO (pulled to machine from the kiosk server) to match the BOL (or rather, the actual new inventory if the shipment was different for some reason), and then commits it to the e-Dispense server.
3. The BOL is encoded into RFID card and included in the shipment. When the kiosk is stocked, the BOL card is inserted. The stocker would still need to be able to modify this in the event that the shipment and BOL differ. This would complicate the shipping process.
4. While stocking, each SKU is “checked-in” to the kiosk by passing it over the QA Shelf (stocker puts machine into ‘check in’ mode). An interface to manually edit the e-Dispense inventory numbers may be required. The display will not be visible. If the stocker has a PDA then the PDA could connect via network cable/WIFI to the kiosk server. If the shipment, the BOL and the PO all coincide (the ideal scenario), then the stocker is able to update the e-Dispense inventory database using the display and keypad on the machine.
6. Deployment Considerations

Before a kiosk is installed at a clinic/doctor's office, a site survey is preferably conducted to identify what additional changes are required to ensure proper operation. In particular, the survey should identify the following:
1. Are there electrical outlets in the area?
2. Is the quality of the electrical power within spec for the kiosk Unit?
3. Is there sufficient cooling/ventilation?
4. Is it a reasonably secure location? What is the potential for vandalism or theft?
5. Is it within a reasonable line of site with the administrative area?
6. Is there cell-phone coverage and/or signal at the location?
7. Security

If the Prescription comprises a prescription ID, it may be unnecessary to use additional encryption. All personal information for the patient is stored on a server and will be inaccessible to anyone or any machine that does not have access to the server.

For the kiosk itself, there will be no window in the dispensary. There will be sensors within the machine to indicate that door was opened, and all door open events will be logged. With the lock closed, the circuit is armed. Any disturbance will cause the alarm to trigger. With the lock open the circuit is disarmed, however, if there is any tampering with the inside of the delivery area, a warning will be generated. All warnings and alerts are sent to the server to notify appropriate staff

Access to the kiosk will be granted in three separate ways:
1. An employee card is assigned a magnetic card that is an encrypted access card. If an employee uses the same employee card at different clinics while at one clinic then a cloned card is in use. This type of usage should be detected and the locking out of both cards would occur.
2. A PIN number provides access, using either the touch screen or keypad.
3. A physical key provides access, similar to other kiosks.

The employee card and the PIN will release the electronic lock, and the physical key will release the physical lock. When the door is open with authorization, the machine enters a maintenance/admin mode which enables extra functionality that is not otherwise available, e.g.: (i) using the embedded cell-phone to call central office; and (ii) using the display and keypad for editing machine parameters and/or initiating communications with a central server.

If unauthorized access if detected, a small concealable wireless camera will begin recording. There should be source of illumination when the door is opened sufficient to light up the face of an intruder. One option (for streaming video or photos) is to use a wireless system based on 802.11, for example, such that the camera is essentially a peripheral of the local Kiosk server. An 802.11 repeater may be needed. All wireless components should be limited to known MAC addresses and encrypted traffic. Another option (for photos only) is to use a camera tied to the customer support cell phone (no 802.11 required).

It should be understood that the implementations disclosed herein contemplate integration with the CMS system, as described above. Alternatively, implementations disclosed herein is operable to send a message to a CMS system, which is preferably an encrypted electronic message. In response, Implementations disclosed herein preferably received an electronic message that includes encrypted patient information require for processing the prescription.

8. Operational Considerations

Once the medication inventory is reduced to a predetermined low water mark and/or a periodic milestone is achieved, a purchase order (“PO”) type message is sent from Kiosk server to the server. This PO tells the serviced provider what medications the kiosk needs. All other pending service requests will be scheduled at the same time to ensure that a service trip is optimized.

When the drugs for a kiosk are packed up at a distribution center, they are packed so that the shipping box has N smaller boxes. Each small box is labeled with the drug and the color coded SKU, and has a Bill of Lading that shall highlight any changes made to the PO issued by e-Dispense.

The kiosk is opened up, and stocked from the packaged order. In one implementation, every coil is identified with a color-coded SKU. The labeling should be such that the labeling of the coil will match the labeling on the medication packaging and on the medication containers themselves. All new stock is stocked from the back to the front of the Kiosk.

There may be stocking instructions that are issued from the service provider. This could be a request to remove old stock, implement a drug recall of one or more SKUs, or empty the medication reject bin.

When stocking is complete, the inventory in the machine must be reconciled with the inventory database on the server.

For servicing, there is generally a requirement for a pre-determined preventive maintenance schedule. Whenever the machine is serviced, all the normal preventive maintenance checks and servicing should be done.

The used Prescription lock box has a specified capacity. The number of Rx kept in the lock box is monitored by the kiosk and when the predetermined high water mark is reached, a message is sent to the server requesting that this kiosk be serviced. All other service requests will bill queued at the same time to ensure that the service trip is optimized.

When the lockbox is full or nearly full, the entire lockbox is replaced with an empty one, and the full one is taken away by the service provider. When the lockbox is opened the prescriptions should be audited and confirmed that all prescriptions retained by the kiosk matches the prescriptions audited.

Regardless of capacity of the rejects bin, rejected medications should be collected as soon as possible after being detected (and replacement stock put back in the machine). There should be regular maintenance and top-up of consumables (media & ink) for all printers involved, including the Prescription card printer, the color printer for the educational materials, and the kiosk label and receipt printer.

Revenue Generation Model

As discussed above, implementations disclosed herein included a robotic based prescription dispensing system designed preferably for a physician's clinic operation. The system dispenses medicine immediately, conveniently, more accurately and at less cost than traditional drug store based dispensing systems.

Conceptually, the implementations disclosed herein operate as follows: a patient is in the examination room with their physician. The doctor has reached his/her diagnosis and is in the process of writing a Prescription using a computer-implemented device, such as a tablet computer. At this moment the prescription interface notifies the doctor and patient of the drug plan coverage allowing the doctor and patient to make the best decision for the medication they need. When the medication is selected, a Drug Utilization Review (“DUR”) is automatically conducted to ensure there will be no side effects associated with the medication or interaction with other medications the patient is taking. The prescription along with drug education material is then printed.

The patient then walks to a system unit in the waiting room and inserts the prescription. Within minutes, the machine selects the appropriate pre-packaged medication, scans it for verification, and releases it to the patient. The process is painless when compared with the prospect of patients having to travel to fill a prescription. More importantly, the patient's medical record is updated with the record of the dispensing and the patient now is taking their meds immediately, getting better faster. If this is a maintenance drug, the prescription repeat will be delivered to the patient's door within days before their current prescription ends. This seamless integration with mail order delivery improves the chances that patients will continue to take medication as prescribed because the requirement to go to a pharmacy to renew prescription results notoriously in gaps in drug treatments.

Preferably, a service provider attends to all aspects of dispensing operations. In this regard, Implementations disclosed herein is preferably designed as a “turn key” operation for primary care clinics such that all the physician has to do is write the prescription on the ordering tablet. Everything from the installation of the system to its daily maintenance, payment collections and accounting, health benefit adjudication, and inventory logistics and replenishment is preferably operated by the service provider.

It is known that up to sixty per cent of the prescription market is for maintenance drugs. Be it for high blood pressure, high cholesterol, diabetes, depression, etc., patient medication programs require compliance and adherence to prescribed medications in order to maintain good health. Typically, when a patient receives a prescription and goes to a drug store for dispensing, the repeats are captured by the drug store and it is very difficult to redirect the repeats to mail order delivery. However, a system according to implementations disclosed herein effectively capture and divert prescription repeats for maintenance drugs to a home delivery service. In this regard, a service provider will operate a mail-order pharmacy for two purposes: (i) to repackage bulk medications into standard prescription doses for the dispensing system inventory; and (ii) to offer mail order delivery services so that patients will be offered the convenience of home delivery with the service provider retaining this important revenue stream. The mail-order pharmacy and home delivery service is significantly less costly than pharmacy-based operations and takes advantage of the automation prescription drugs for order fulfillment.

Further, it is known that an average physician writes approximately 10,000 prescriptions per year. This corresponds to enormous revenue generated for pharmacies. Implementation disclosed herein are designed to dispense medicine inside physician clinics or directly to patients' home, delivering a more convenient service to patients while capturing a portion of the revenue stream that would otherwise go to pharmacies. Where appropriate, pharmacies can be given access to some or all aspects of the system, for example, in order to facilitate the choice of the patient or other situations where it is desirable for the patient to have the prescription filled by the pharmacy. Either way, however, the dispensing of drugs by doctors enables redirecting of certain revenue to doctors which in turns relieves pressure on the health care system and enables doctors to take the time required to cover drug related issues such as interactions more exhaustively and using better tools than what is currently possible under the existing system. The doctor is the entry point for patients to a drug therapy regime, yet the pharmacies have the tools, information and time to cover important health related aspects thereof. The medical details of a drug therapy regime are in the current system not fully passed on from doctor to pharmacists, which results in many cases in a loss of efficacy in the therapeutic effect, inefficiencies, miscommunication, the need for pharmacists to follow up, inconsistent instructions and so on. Implementation disclosed herein enable doctors to be given with better tools to manage drug treatments resulting in a more seamless healthcare system and better healthcare for patients.

It is also known that physicians routinely prescribe on average only 16-18 drugs for their patients. Implementation disclosed herein are designed to service a physician's prescribing routine and cover a majority of their particular dispensing requirements.

Primary care physicians and related secondary healthcare services are increasingly organized in medical buildings that are designed specifically to address the multi-faceted needs of a divergent patient population. However, the most under-invested sector of healthcare for Communications and Information Technology (CIT) is the primary care physician's office. The reason for this is that for the doctor CIT has not offered sufficient tangible benefits to make the investment worthwhile. Furthermore many doctors' offices do not attain the scale of organization to make a significant CIT investment a priority or justify the staff required to support CIT operations. This technology investment can be leveraged to improve healthcare with the doctor's office as the point of contact, e.g., by delivering multimedia information on medical treatments, accessing rich content from databases, mining prescription information based on up to date information regarding drug interactions etc.

Implementations disclosed herein address the foregoing in the following ways: (i) Implementations disclosed herein are delivered as a turn key solution with no up-front investment required by the physician; (ii) Implementations disclosed herein offer an incremental revenue stream that provides sufficient incentive for the physician to adopt the technologies; (iii) Implementations disclosed herein aggregate physician practices to the scale required to generate appropriate returns on CIT investment; (iv) Implementations disclosed herein deliver the organizational ability to make a CIT investment mutually beneficial for the physicians and the patients; and (v) All CIT support functions are operated by a service provider eliminating any impact on physician or clinic operations and overhead. Implementations disclosed herein also addresses accuracy and efficiency issues common with pharmacy-based dispensing.

By way of example, prescriptions written in Canada can be paper-based. This results in up to ten percent (10%) of prescriptions requiring the physician to be called by the pharmacy because of they are not legible. Furthermore, studies have documented that adverse events associated with prescription errors, some resulting in patient death. Medication errors come under public scrutiny, as they are a substantial and leading cause of death and injury in the USA. Implementations disclosed herein address these problems, ensuring more secure and accurate fulfillment of prescriptions.

Implementation disclosed herein provide an automated apparatus for dispensing medicaments which advantageously provides improved utility to expand the variety of medicaments that can be stored, prepared and dispensed. Its utility is enhanced by increasing the prescription coverage ratio offered a patient at an autonomous network device or drug dispensary apparatus. This utility of service provided by the apparatus may be viewed from the perspective of a patient (i.e. user) standing at the doctor's office with a prescription in hand and needing immediate medication. The distance the patient must travel and the frictions the patient must overcome to get the medication is the patient's utility function. Utility from the perspective of the drug dispensary, be it a pharmacy or a remote dispensary apparatus as provided by implementations disclosed herein, means how many items on the patient's prescription could be filled, not requiring secondary actions, such as ordering the medication requiring the patient to return for pick up, or delivering the medication to the patient at a later time. Thus, for both the drug dispensary and the patient, maximum utility is determined by the ability to dispense all medications required, on the spot, at the time of the initial interaction. Advantageously, the dispensary apparatus of an implementation disclosed herein is constructed from a preselected number and functional type of modular components, hereinafter referred to generally as modules. These modules include a front end user-interface module, a back end drug vault module in which drug product for dispensing is stored, and a control system which is located for operation with both the front end and back end modules. These modules are dimensionally compatible for assembly in numerous combinations, as desired for a particular application, and their internal components are sized and shaped to conform to a grid configuration to enable such compatibility and interconnectability, such that numerous combinations of modules can be assembled and interchanged as desired. This allows an unlimited number of combinations to be configured from an inventory of interchangeable, compatible modules and allows the apparatus to accommodate a wide variety of requirements for a given application.

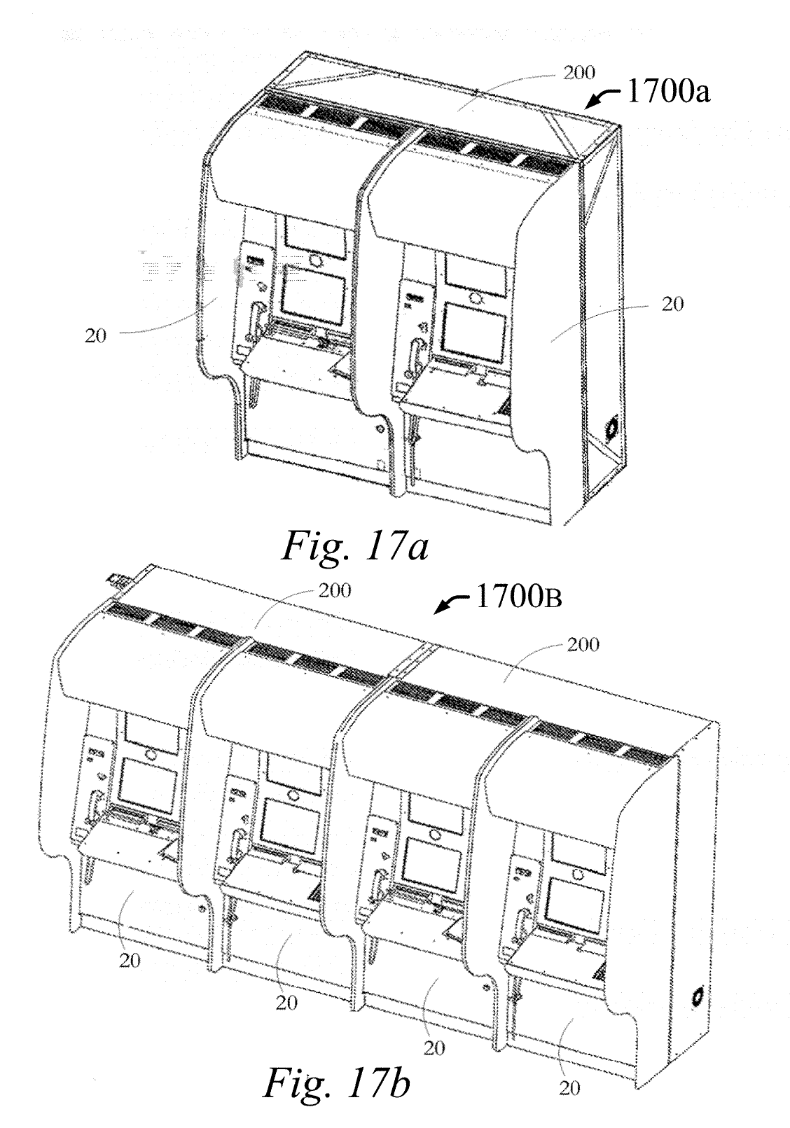

Referring to FIGS. 17a-23, the front end user-interface module is provided both as a half size and full size module allowing, for example, one large and two small user front ends to be attached to a back end module 200, or two, three or four front end modules to be attached to two back end modules. Within the back end module 200, several optional configurations may be assembled to accommodate product inventory as desired. For example, within a back end module any combination of product storage modules may be selected. A controlled room temperature section may be included together with a refrigerated temperature storage section. Multiple storage container racks may hold any combination of product storage modules, including product storage containers for pre-packaged product, bulk medication storage containers for liquid product and bulk medication storage containers for pill/capsule product. If desired, a reconstitution, mixing and/or compounding bulk medication storage container can be added in place of a refrigerated storage module or assembled into a second back end module. The modularity of the components of the apparatus is defined in standardized manner to dictate dimensions, key contact points, power, network configuration points and mechanical features, to ensure interoperability for all components and their associated software, hardware and operational parameters.

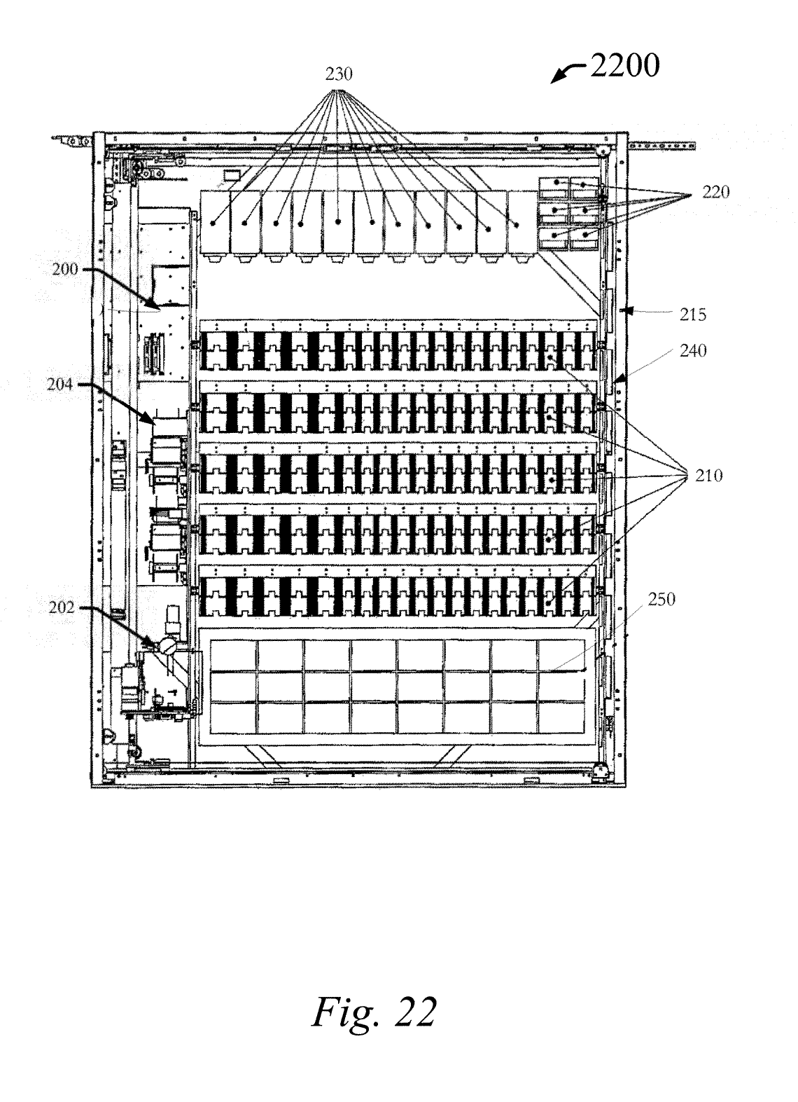

The front end user-interface module is independent from the back end drug vault module 200 shown in FIG. 22, whereby they may be co-located in a single chassis as a unified apparatus, or located in appropriate multiples to meet a particular service location requirement. Most commonly, multiple front end modules can be co-located with a single back end module and both front ends (or multiple front ends) are serviced by a single control system and back end drug vault. This is shown by FIGS. 17a-17b, respectively at reference numerals 1700a-1700b, in which FIG. 17a shows two, side-by-side front end user-interface modules share one back end drug vault module and FIG. 17b shows four, side-by-side front end user-interface modules and two back end drug vault modules, whereby each of two side-by-side front end modules share one back end drug vault module. Multiple back ends can also be linked to extend storage capacity to serve a front end user-interface cluster.

In yet other implementation, a sub-assembly of two inter-connected back end drug vault modules are configured. A further configuration, which may be desirable to service remote communities with low transactional volumes and long times between inventory replenishment, is multiple back end modules serving a single front end module. The kiosk system is improved to, inter alia, provide dispensing reliability of prepackaged drugs which have a range of sizes, shapes, weight and weight distribution (e.g., a heavy dense glass vial on one side and a light weight dropper on the other side of a package renders an uneven weight distribution for the package), slipperiness of packaging, tabs, stickiness, moisture (e.g., from absorption by cardboard), all of which create a plurality of handling problems for robotic systems. Also, drug companies frequently change packaging, so control algorithms may become ineffective when a package change alters an SKU (Stock Keeping Unit) which may be used by the robot to identify the package. Therefore, a robotic control algorithm that prescribes a handling method based on pre-recorded product package information (weight, size, etc.) is subject to errors, simply because the packaging was not intended for automated dispensary, and there are currently more than four thousand package variants for common medications, that vary by region, manufacturer, re-packager, or distributor.

To deal with this problem, some known systems create uniform over packaging to assist in robotic dispensary reliability, but this adds additional handling and expense to the dispensary process, a significant increase in the opportunity for error, and additional waste stream burden to products already notorious for over packaging. The kiosk system overcomes the foregoing problems of the prior art by using a “state based machine” based on controls, behaviors and sensors on a robotic pick head. Current medicament packaging is generally designed for handling by personnel, not automated machines or robotic machines.

Humans can compensate instantly and intuitively to variations, changes and anomalies. Machines such as robotic dispensaries are not smart, and require a refined set of behaviors to compensate for common anomalies. Several networked video and/or still cameras can be installed inside the kiosk to view what is taking place in the apparatus, and this visual information is used by the kiosk system as well as remotely, if needed, by a human agent. To compensate for the fact that machines, unlike humans, do not intuitively compensate for gripping items, the kiosk system is computer-controlled by a state machine (being firmware), associated software and a z-axis encoder (for positional feedback control) to react to what happens and read the values of the various sensors, which include product position sensors and z-axis positional sensors. For example, if a drug product being picked from inventory by the kiosk system is fully registered to be positioned at the back of a platen of the pick head assembly, then the kiosk system knows that pick was a successful pick and a tractor of the assembly can then feed it off correctly. A computer of the kiosk system knows the length of products so the module determines from the sensors being simple light beam sensors, where a product should be located. The array of sensors enables the kiosk system to determine what state it is in at any given moment. The kiosk system operates, for example, to pick a product out of the back end drug vault module, by using “state tables” of approximately 385 states, each state functioning as a rule.

Intelligence is provided to the dispensary apparatus (e.g., kiosk) to solve problems, this being achieved by pick head sensors, product information, machine states, behaviors and behavior results. A state determination is made from sensors and product knowledge, determination of a state leads to a selection of behaviors, behaviors are executed in order of success and success of behaviors for particular states increases the intelligence (knowledge learned) of the apparatus and system. The hardware of the kiosk system operates at a first layer of control, while the state machine operates at second layer. The hardware includes a set of behaviors, including jiggle pick, shelf recovery, and others. The state machine drives which of the behaviors the robot is to apply and a series of states are provided with a score. The states know whether one state is better than another is. For example, an optimal state would be registered where a product is located at the correct identifier number with the sensors identifying it to be fully registered at the back of pick head measured against product specific information out of the system's database. At the time of a product pick by the kiosk system, the product is known because it was measured and its length was recorded when the product was serialized and put into inventory in the apparatus. Also known by the kiosk system is the size, the weight, the shape, the moment arm, and other particulars pertaining to the location of the product to be picked.

The software driving robot knows what it is supposed to expect and the robot deduces what states should occur in order to be successful. It also deduces when it gets into a state relative to what the product is and by combining the product information and sensor information it deduces what to do next to be successful. The kiosk system is controlled to do anything it can deduce to be successful.

A neural network is used by the system and each networked kiosk system to allow it to learn from previous actions and results. State transitions may provide learning knowledge to the kiosk system. For example, if the robot achieved a particular state and used a particular behavior to get to that state, this is learned knowledge which is maintained by the kiosk system for future use. A collection of different behaviors can be applied by the robot. If the robot is in a similar state as it was previously, and it previously tried a behavior which did not succeed, then it will not try the same behavior and, instead, will try another behavior. The control system is controlled to apply behaviors based on risk levels, to become progressively more aggressive to achieve success. In a state table, the states reflect this progression for control of the robot so that, for example, it will attempt one (1) for, say, shift recovery, then attempt two (2) for aggressive shift recovery, and then attempt three (3) for maximum shift recovery. The kiosk system is also controlled to do anything in its power to get unstuck, so it does not jam (since the apparatus is unattended). The primary rule applied by the robot is that it must not jam. For the robot, to not a make an error is a lesser rule (having lower priority) because the robot has access to a waste container and a waste arm that it uses to direct damaged product. If the kiosk system detects an error, it transfers the product to the waste container. The robot applies is hardware, then state machine behaviors to achieve its primary directive of no jamming. If after three attempts to pick a product it is not successful, it reverts to remote control mode by invoking a call center screen for a human agent who is alerted that an error occurred and manual recovery is required. The human agent can look at the screen through the network and can summon a technical person to commence a remote control application over the network which pilots the robot in real time, enabling the robot to service a user who is standing at the kiosk.

The control software of the kiosk system acts to try to correct errors when they occur. The robot picks a product from its storage location by bringing the pick head to the storage location slot. The slot has a gap in front to allow the pick head to insert a tongue into the slot under, or against, the product. The pick head has multiple belts (or wheels or fingers) to pull, or to drag, the product forward as the pick head moves up and onto a shelf of a storage container rack while lifting the product up or while riding the product on the pick head. This action picks up, or slides, the first product on the storage shelf location, separating it from the remaining inventory, which is to (ideally) remain on the shelf The pick head then senses the size, shape, weight of the product it has picked to determine that it has picked a single product unit and determine that it has overcome three common errors, namely, a stuck pick (where the product sits in place due to slipperiness), double pick (where two products are either in close proximity, tangled together or stuck together) and multi pick (usually due to labels sticking together). The state machine, using sensors and a tables of information about the inventory product being dispensed, determines the error based on the physical parameters of dimension and weight and, for product containing RFID (Radio Frequency Identification) tags, by scanning and detecting the presence of more than one RFID tag, or more than one bar code if bar codes are presented in such a configuration as to make them visible. Based on the foregoing information, the kiosk system determines with a high degree of accuracy whether the product is present, whether an error exists and, if so, the state of the error. Upon occurrence of an error, using the error state information the robot implements an escalating series of interventions in an attempt to resolve the error. If no product is present in the pick head and the robot knows there is product in the slot, then machine state is a stuck pick. In this state, the robot implements a first level stuck pick resolution action called a Jiggle Pick™ machine action, for which a software control loop causes the robot to oscillate up and down within a range of motion and velocity determined to be appropriate for level one resolution range. With the Jiggle Pick™ machine action, distance is important for effectiveness and to minimize damage to the robot, storage shelf and product. Sensors on the pick head determine penetration into the shelf and maintain a safe distance from the surfaces to minimize the possibility of contact damage. The Jiggle Pick™ machine action causes the stuck product to unstick from the shelf, in much the same way that a vibratory conveyer overcomes friction to move goods.

Two products may stick together causing two products to be loaded into the pick head rather than one product. In the storage bin, the mean angle between the panels of each product box is shallow and this may cause two package boxes to mate when sitting next to each other with pressure or if cardboard and subject to humid conditions. This increases the chance that when the pick head lifts one box, it may actually lift both, creating a double pick error. To resolve this, an escalation to a level two remedial action is implemented by the local control software creating a shift higher on the control head, to alter the angle the product is held at, thereby reducing the contact area between the first and second product, to create a separation angle, and create the contact point that disallows mating, therefore only pick one box. A third common pick problem is multi pick, where several products are stuck together, typically due to the label or label glue affixing several packages together. The sensors and machine operating software are able to determine a multi pick error based on weight, moment arm of the load, dimensions of the load and load behavior measured by parameters of acceleration and deceleration lag. If the multi pick error cannot be resolved by the foregoing resolution one or two, the local operating software escalates to resolution three, whereby an edge of a pick bin is used as a guillotine to wipe the redundant products from the picked product. As the wiped product may have been damaged or compromised by a level three intervention wiping action, any wiped product is placed in the waste container and is not dispensed without prior confirmation of integrity.

A drug dispensary apparatus must be reliable, measured primarily in terms of availability for service. The ideal machine would be one that never fails, but the very nature of integrated communications, software and hardware, and variety of products and packaging that must be handled, invariably lead to an error rate greater than zero. However, errors are probable and, therefore, error management, isolation and recovery are paramount to prevent failure. A core reliability algorithm used by the apparatus 10 of an implementation disclosed herein is defined in terms of absolute parameters or edicts. Each edict overrides subordinate edicts, with edict one overriding all others. The edicts are the following:
Edict One: Patient Safety-Preferably, no activity can compromise patient safety.
Edict Two: Protection of Assets-Preferably, no activity can compromise in order, the security of the drug inventory or the security of the machine.
Edict Three: Maintain Operability.

Edict Two preferably has escalating procedures that do not require the machine or the drug vault to be opened. Edict Three requires that the escalating procedures be as succinct as possible to maintain an in service status and core utility of the apparatus. The dispensary apparatus is networked to a computer system so that any error occurring at the apparatus with respect to product (SKU) becomes a shared network experience and part of a common error record contributing to the accumulated knowledgebase of the system. Error parameters forming trends can be analyzed, such as, errors common to a specific machine, or specific machine configurations, or specific conditions, or specific packaging or product variants. As components of a neural network, each software controlled robot has pre-programmed autonomous actions, and being a state machine is able to adapt to changes to deliver the desired result under the control of a strictly applied rule

As stated, the robot's state machine in effect learns to recognize conditions and acquires knowledge in the form of a recorded history of the result of various solutions, thereby adding to the collective operation knowledgebase, to allow the robots of each of the networked dispensary apparatus to learn from a successful outcome. For example, a product jam that entraps the pick head is a common reason for a dispensary apparatus to be out of service. The robot has a set of procedures to unstick itself. It knows its slot location and it knows the product SKU on the platen, but it may find that its X and Y axis movements are arrested.

If the database has no prior occurrence of this specific problem, the software begins the following resolution sequence, starting with the least destructive behavior: jiggle gently, yes/no resolution; escalate to jiggle intensely, yes/no resolution; escalate to jiggle intensely while pulling back the platen, reversing the pickup belts and while applying X axis up, to force the product free, sacrificing the product to the discard bid (this action will discard one product SKU), yes/no resolution; escalate to ramming the platen forward into the slot and elevating the contents of the slot, then dropping them into the waste container (this action will discard all remaining product SKU's in the slot, but if successful, frees the robot to pick and dispense from the remaining slots), yes/no resolution; revert to shut down, call for help center technical intervention, open a remote pilot session, whereby the multiple cameras within the apparatus allow a technician at a remote repair center location to see inside the apparatus and to take over remote piloting of the robot to resolve the issue (this action avoids on site intervention and the apparatus is not opened so no security issues arise with this intervention), yes/no resolution; escalate to local call out whereby a qualified local technician who is certified to enter security level one (front of machine) is dispatched to the site, opens the front of the machine and can repair the problem if it is external to the drug vault, yes/no resolution; lastly, escalate to truck roll whereby a senior technician is called out, and the senior technician is authorized to security level two (drug vault access) and can resolve the issue by opening the back end drug vault module(s).

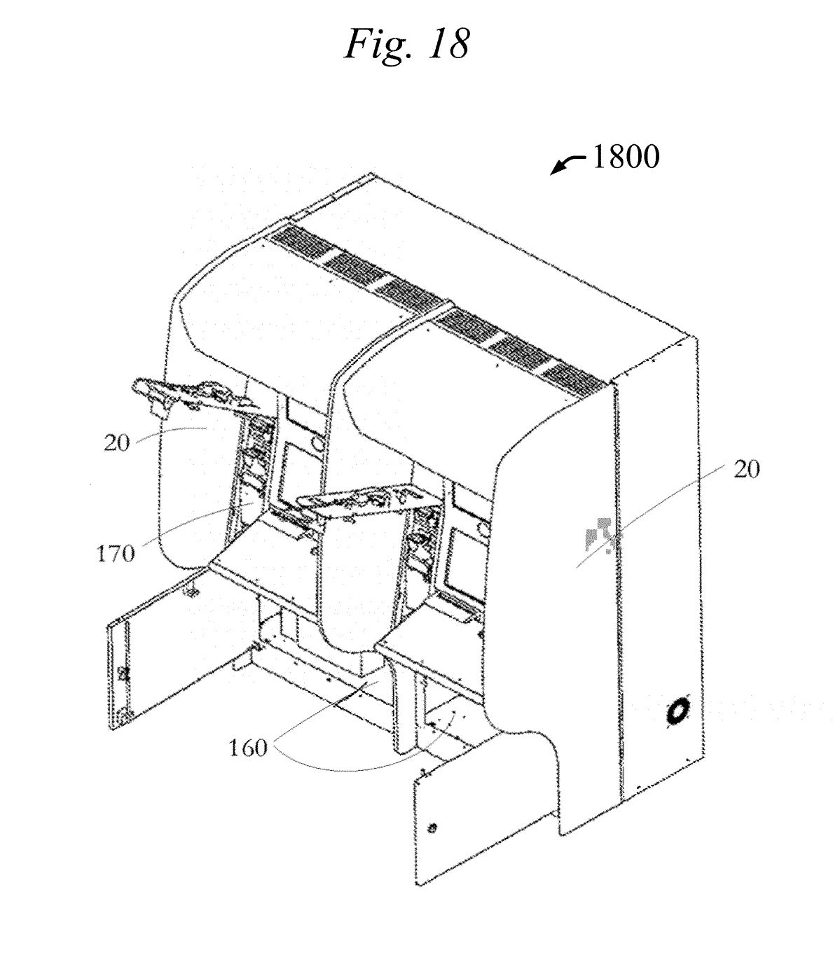

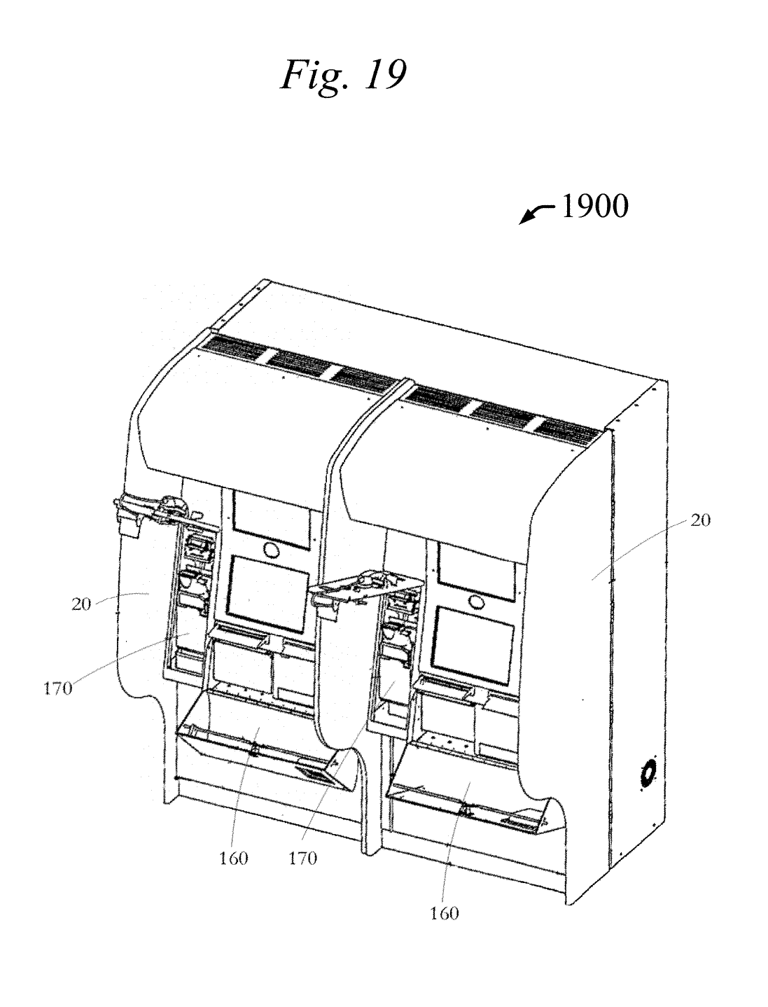

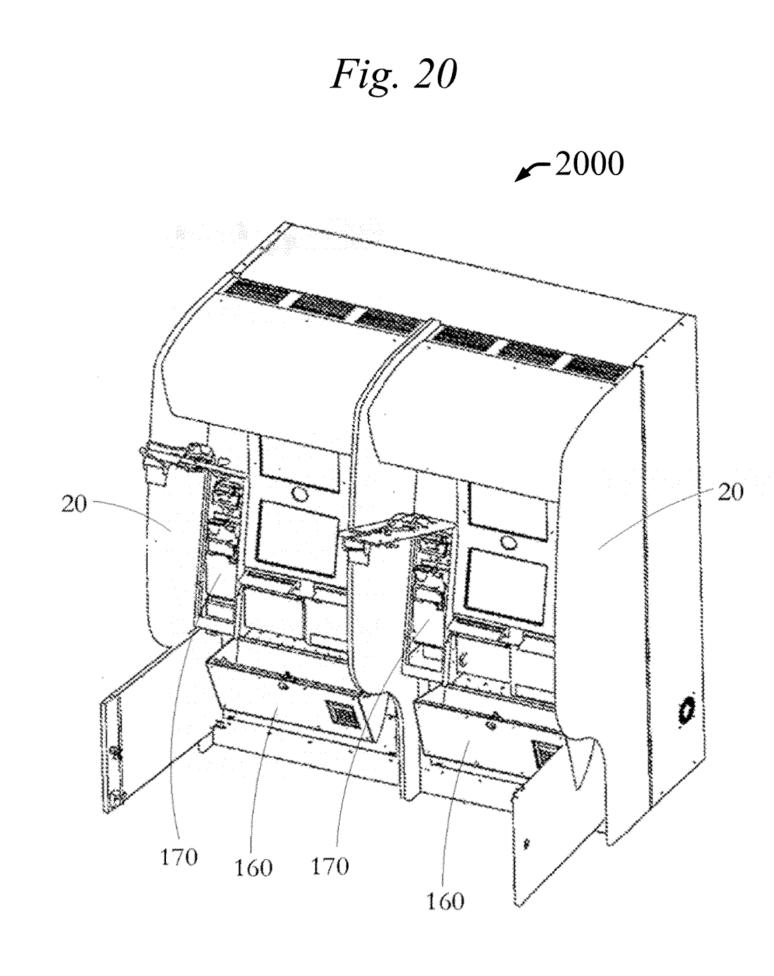

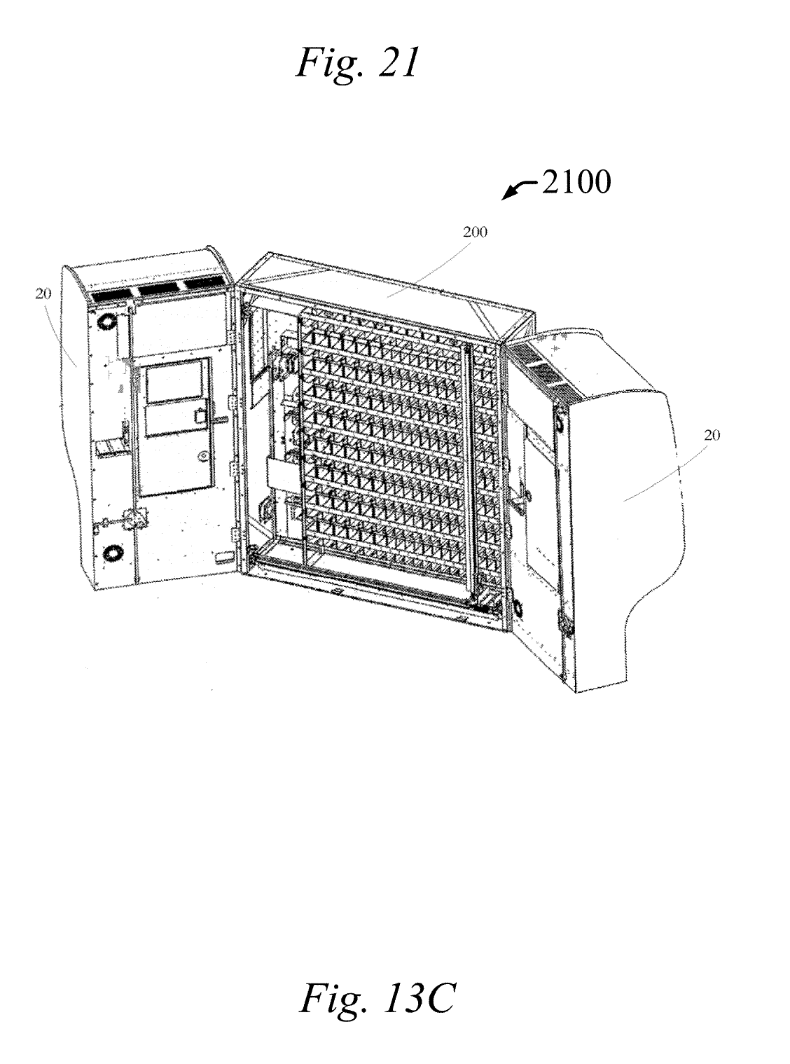

Referring now to FIGS. 18-21, FIG. 18 at reference numeral 1800 shows a level of access to the kiosk provided by exposing several internal components thereof via a corresponding variety of access panels. FIG. 19 at reference numeral 1900 shows another level of access to the kiosk provided by exposing several internal components thereof via a corresponding variety of access panels. FIG. 20 at reference numeral 2000 shows yet another level of access to the kiosk provided by exposing several internal components thereof via a corresponding variety of access panels. FIG. 21 at reference numeral 2100 shows a still further level of access to the kiosk provided by exposing several internal components thereof via a corresponding variety of access panels.

In further reference to the foregoing staged error resolution process, the kiosk determines when an error state occurs and is able to resolve the error which has been detected, serves to maximize the in-service time of the apparatus, maximize patient utility, provide a rapid response to an error, provide a low service cost structure and optimize security for the machine and the drug inventory. The physical security of the kiosk is enhanced by a staged access configuration of the apparatus as illustrated by FIGS. 18-21, where access is provided at locations to the front part of the kiosk which houses the user interface components, waste section, pick head garage and regular dispensary service items.

Another access level is illustrated by FIG. 21 and provides access to the drug vault module including its refrigerated section (if any) and its bulk storage containers which controlled and isolated. Two types of security are applied to these access levels. The technician must have a valid ID badge to allow entry to the front end of the apparatus.

A network video and/or still camera confirms the identity of the technician, that the technician's credentials are current and authorize the technician to access the machine at that time and that there is a work order created to track time and activity at the dispensary apparatus. In the event that a network connection cannot be established by the apparatus due to network interruption or prolonged power failure beyond the hold up time of an internal UPS, a controlled access key can be used for access to the level one interior space to restore power or network connectivity. Access to the level two controlled regions of the apparatus, such as the drug vault module, can only be achieved with network confirmation.

To optimize the user's utility in relation to the dispensary apparatus and serve a high traffic level, the apparatus must provide a high level of prescription coverage. An obstacle to doing so is that some medications, like insulin for diabetics, eye drops for glaucoma and several pediatric medications, require refrigeration for storage and such medications can be rendered ineffective if stored outside of their temperature range (e.g., if outside such range by two to eight degrees Celsius). On the other hand, some medications such as syrups require room temperature storage which is defined as fifteen to twenty-nine degrees Celsius.

Advantageously, the kiosk of an implementation disclosed herein overcomes this obstacle by providing an isolated refrigerated section in the drug vault module that can store medications at controlled refrigerated temperatures in combination with a controlled room temperature section in the drug vault module to store medications at room temperature, by way of example, as shown by FIG. 22. The kiosk also contains monitoring sensors (not shown) within the storage areas to sense internal temperature for the purposes of control of temperature, as well as to monitor temperature to report to a log file for correct temperature storage verification for a drug pedigree file and to report any temperature fluctuations in the form of high or low temperature alarms to the network for remedial action. Any drug that has been exposed to a temperature, or time and temperature beyond its allowable range is tagged to identify this via a drug pedigree established by the system and is removed from accessible inventory for disposal.

The kiosk can be an implementation able to dispense only pre-packaged product, being single unit items referred to as “standard dosage” items or packages. Pre-package products indicate that the items are appropriate for use in the dispensary and for dispensing to users but the actual number of pills, capsules, etc., contained in a given standard dosage package will vary based on the drug and dosing regimen. This regimen is derived from information provided by the drug manufacturer and the common dosing practices for the drug in question. However, from the perspective of utility function for the user, the dispensary apparatus is non-functional if the prescription requires pills and the apparatus only stocks pills standard dosage packages. The kiosk solves this common problem by providing in its back end drug vault module a bulk medication storage area and pill counters integrated into bulk storage containers for pill/capsule products.

A common problem encountered in autonomous pill counting is reliable, secure and clean handling of medication without cross contamination. The kiosk can include a larger bulk pill/capsule storage container that allows medication to be securely stored in bulk and sealed, and only touched by dedicated handling equipment until dropped into a dispensary package and dispensed to the user. This conforms to a no touch technique SOP to eliminate the possibility of cross contamination. The storage container has specific dimensions to allow it to be stored in a standard storage slot, and specific features to enable reliable handling by robot. It also has specific security features to make it tamper resistant in transit.

Referring to FIG. 22 at reference numeral 2200, implementations disclosed herein provide an automated apparatus for dispensing medicaments which advantageously provides improved utility to expand the variety of medicaments that can be stored, prepared and dispensed. Its utility is enhanced by increasing the prescription coverage ratio offered a patient at an autonomous network device or drug dispensary apparatus. This utility of service provided by the apparatus may be viewed from the perspective of a patient (i.e. user) standing at the doctor's office with a prescription in hand and needing immediate medication. The distance the patient must travel and the frictions the patient must overcome to get the medication is the patient's utility function. Utility from the perspective of the drug dispensary, be it a pharmacy or a remote dispensary apparatus as provided by implementations disclosed herein, means how many items on the patient's prescription could be filled, not requiring secondary actions, such as ordering the medication requiring the patient to return for pick up, or delivering the medication to the patient at a later time. Thus, for both the drug dispensary and the patient, maximum utility is determined by the ability to dispense all medications required, on the spot, at the time of the initial interaction. Advantageously, the dispensary apparatus of an implementation disclosed herein is constructed from a preselected number and functional type of modular components, hereinafter referred to generally as modules. These modules include a front end user-interface module, a back end drug vault module in which drug product for dispensing is stored, and a kiosk control system 100 which is located for operation with both the front end and back end modules. These modules are dimensionally compatible for assembly in numerous combinations, as desired for a particular application, and their internal components are sized and shaped to conform to a grid configuration to enable such compatibility and interconnectability, such that numerous combinations of modules can be assembled and interchanged as desired. This allows an unlimited number of combinations to be configured from an inventory of interchangeable, compatible modules and allows the apparatus to accommodate a wide variety of requirements for a given application.

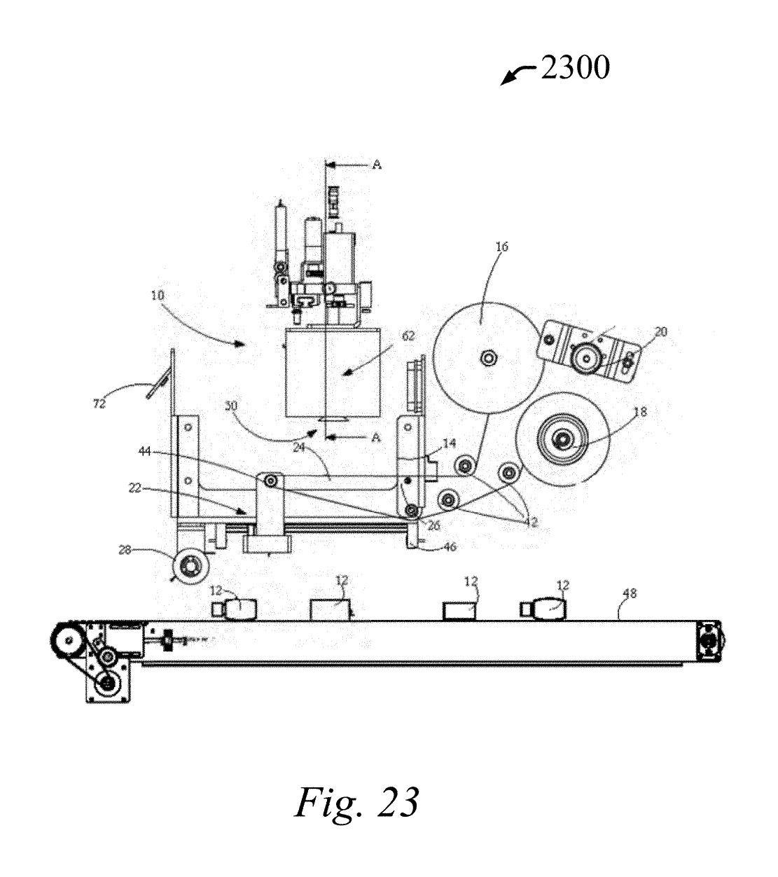

The front end user-interface module is provided both as a half size and full size module allowing, for example, one large and two small user front ends to be attached to a back end module, or two, three or four front end modules to be attached to two back end modules. Within the back end module, several optional configurations may be assembled to accommodate product inventory as desired. For example, within a back end module any combination of product storage modules may be selected. A controlled room temperature section 240, as seen in FIG. 22, may be included together with a refrigerated temperature storage section 250. Multiple storage container racks may hold any combination of product storage modules, including product storage containers 210 for pre-packaged product, bulk medication storage containers 220 for liquid product and bulk medication storage containers for pill/capsule product. If desired, a reconstitution, mixing and/or compounding bulk medication storage container can be added in place of a refrigerated storage module 250 or assembled into a second back end module 200 shown in FIG. 22. A picking component to pick a container of drugs from the inventory thereof in the kiosk is shown at reference numeral 202 of FIG. 22. A labeling component to apply a patient-specific label to a picked container of drugs, an implementation of which is further described in reference to FIG. 23, is shown at reference numeral 204 of FIG. 22. The modularity of the components of the apparatus is defined in standardized manner to dictate dimensions, key contact points, power, network configuration points and mechanical features, to ensure interoperability for all components and their associated software, hardware and operational parameters.

In order to expedite that a user must wait for a picked and labeled container of prescription drugs to be dispensed from the kiosk, both the picking component 202 of FIG. 22 and the labeling component 204 of FIG. 22 can be configured to parallel process their respective functions such that they rare performed simultaneously.

FIG. 23 shows, at reference numeral 2300, a side elevation view of an exemplary labeling station as a component in an exemplary kiosk, and shows positioning of elements thereof in the course of a label printing process according to an implementation disclosed herein. A labeling module 10 is shown which is used to apply labels to medicament packages 12 as they are moved through a labeling station of a dispensing kiosk of the sort disclosed herein. The labeling module 10 has a printer 14, a supply reel 16 for supporting a roll of label stock, a take-up reel 18 driven by a motor 20, and a tensioner device 22. As shown in FIG. 23, the label stock is in the form of a web 24, the web consisting of a release backing, with a series of labels self-adhering to the backing along its length. The labeling module also includes a tamp assembly 62 and a suction device 30.

As can been seen in FIG. 23, as the web 24 exits the printer 14, a spring 28 forming part of the tensioner 22 retracts to pull the suspended part of the web towards the left. This brings the label that has just been printed to a position under a suction device. When a required vacuum level is attained, a vacuum switch is tripped to trigger drive of take-up reel 18 to begin separation of the gripped label from its backing. The web is driven around an assembly of rollers including guide rollers 42 and a retractable, small diameter, roller 44 forming part of the tensioner 22. As an advanced length of the web 24 is wound onto the take-up reel 18, the part of the web suspended at the tensioner roller moves to the right as the tensioner spring bias is overcome by the pulling force applied to the web 24 from the take-up reel. A label, because it is gripped at a suction cup, is prevented from moving with the suspended web and when the adhesive force between the gripped label and the backing is overcome, the label is stripped from the backing. To encourage separation, the label can be made from a paper or a plastic that is relatively stiffer than the backing to which they adhere. With such a structure, a label tends to separate progressively from the backing as the web 24 is fed around the tensioner roller 44 because the label is unable fully to conform to the shape of the roller. With the suspended web fully withdrawn and as monitored by a position switch 46, as shown in FIG. 23, a package 12 to which the suspended label is to be applied is exposed on a conveyor 48, the conveyor operating to move packages in the direction of arrow A synchronously with the operation of other elements of the labeling module.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more Personal Computers (PC), one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

By way of example, the web enabled devices 102 seen in FIG. 1 communicate with a server. While the latter can be programmed using server-client coding methodologies, an application executing on the former can be a thin client mobile web browser or an application specific to perform implementations described herein. Such a specific application can be coded to execute on a mobile device running an open source operating system. For example, the Tizen operating system can be used as the operating system for the mobile devices 102 seen in FIG. 1, which can be a smartphone, a tablet, a phablet, an in-vehicle infotainment (IVI) device controller or “headunit”, or other web enabled mobile computing device.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF), visible and invisible light (e.g., infrared or IRDA) data communications. Common forms of computer-readable media include, for example, a hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 4G LTE, and the like as yet to be developed.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device which accesses data in such a database.

Other Separate Devices

It should be noted that, in some implementations, some or all of the functions and method steps described herein may be performed partially or entirely by one or more separate devices which are not necessarily retrofitted to a vending machine. Separate devices for use with such an implementation include, but are not limited to, kiosks, computers, personal digital assistants (PDAs), and cellular telephones. In some implementations featuring separate devices, such separate devices may not necessarily communicate with the vending machine control system. In other implementations featuring separate devices, such devices may be capable of communicating, directly (e.g., via BlueTooth™ connectivity) or indirectly (e.g., through web server or IVRU), to a vending machine control system in order to facilitate the inventive functionality described herein. Such implementations are described more fully below with reference to the Network Implementations section.

Network Implementations

Implementations can be configured to work in a network environment including a computer (e.g. a personal computer, mainframe, PDA, cell phone, or other device) that is in communication, via a communications network, with one or more vending machines. The computer may communicate with the vending machines directly or indirectly, via a wired or wireless medium such as the Internet, LAN, WAN or Ethernet, Token Ring, or via any appropriate communications means or combination of communications means. Each of the vending machines may comprise computers, such as those based on the Intel® Pentium® or Centrino™ processor, that are adapted to communicate with the computer. Any number and type of machines may be in communication with the computer.

Communication between the vending machines and the computer, and among the vending machines, may be direct or indirect, such as over the Internet through a Web site maintained by a computer on a remote server or over an on-line data network including commercial on-line service providers, bulletin board systems and the like. In yet other implementations, the vending machines may communicate with one another and/or the computer over RF, cable TV, satellite links and the like.

Some, but not all, possible communication networks that may comprise the network or be otherwise part of the system include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that vending machines and/or computers in communication with each other need not be continually transmitting to each other. On the contrary, such vending machines and/or computers need only transmit to each other as necessary, and may actually refrain from exchanging data most of the time. For example, a vending machine in communication with another machine via the Internet may not transmit data to the other machine for weeks at a time.

In an implementation, a server computer may not be necessary and/or preferred. For example, in one or more implementations, a stand-alone vending machine and/or a vending machine in communication only with one or more other vending machines may be employed. In such an implementation, any functions described as performed by the server computer or data described as stored on the server computer may instead be performed by or stored on one or more vending machines.

In other implementations, a vending machine may be in communication with a remote computer, such as a server, that provides the vending machine with and/or receives from the vending machine, e.g., all or some of the data described herein, including questions and answers. Thus, in certain implementations, the server may comprise certain elements or portions of certain elements such as a data storage device/memory.

In some implementations, the remote computer may be accessible, directly or indirectly, via a separate device (such as a personal computer, PDA or telephone) by a customer or operator. Accordingly, a customer or operator may use a device to communicate with the remote computer. A device may receive from the remote computer messages described herein as being output by the vending machine (e.g. questions and possible answer choices), and/or may transmit to the remote computer input described herein as being provided to the vending machine (e.g. questions and answer selections). Thus, various data described herein as received through an input device of a vending machine (e.g. answer selections) may be received by the vending machine from a separate device (e.g. through a BlueTooth™ connection) or from a remote computer (which may relay data first received from a device such as a personal computer). Similarly, various data described herein as received through an input device of a vending machine may be received through a Web browser communicating with a remote server, which in turn communicates with the vending machine. Thus, an owner/operator of the vending machine may have remote polling and reporting capabilities, may be able to transmit new business rules (e.g., new question and answer sets) to the vending machine, and the like.

General Software Architecture

In one implementation, a software-based control system executes instructions for managing the operation of the vending machine, and in particular in accordance with the inventive functionality described herein.

In some implementations, machine peripherals (e.g. machine hardware, including mechanical hardware such as input devices, output devices, inventory dispensing mechanisms, and payment processing mechanisms including coin acceptors, bill validators, card readers, change dispensers, etc.) will be controlled by the software-based control system through an interface, such as a standard RS-232 serial interface. In such implementations, embedded API/devices may be used to enable the software to actuate/control vending machine peripherals via RS-232 connectivity. Such vending machine peripherals may be operatively connected to the control system directly or indirectly, in any manner that is practicable.

The terms “an implementation”, “implementation”, “implementations”, “the implementation”, “the implementations”, “an implementation”, “some implementations”, and “one implementation” mean “one or more (but not all) implementations of the present invention(s)” unless expressly specified otherwise.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

1. A computer-implemented method comprising:
communicating a new prescription order:
from a web-enabled mobile computing device at a first location;
to fill a new prescription;
for a pharmaceutical prescribed by a healthcare provider to a patient, wherein:
the communicated new prescription includes an image captured by an image capture device of the web-enabled mobile computing device; and
the captured image is that of the new prescription for the pharmaceutical prescribed by the healthcare provider to the patient;
communicating video teleconferencing traffic between a pharmacist at a second location and the patient at a third location selected from the group consisting of:
a location of the web-enabled mobile computing device used to place the electronic order for the new prescription;
a location of a drug dispensing kiosk; and
a combination of the foregoing;
communicating input from the patient to the drug dispensing kiosk when the patient is co-located with the drug dispensing kiosk;
communicating, in response to the input from the patient when co-located with the drug dispensing kiosk, input from the drug dispensing kiosk to the pharmacist at the second location; and
communicating a dispense order to the drug dispensing kiosk, in response to input from the pharmacist, to dispense the new prescription to the patient from the drug dispensing kiosk.

2. The computer-implemented method as defined in claim 1, wherein the dispense order includes instructions for the drug dispensing kiosk to:
prepare a label bearing patient-specific information from the new prescription for the pharmaceutical prescribed by the healthcare provider to the patient;
apply the label to a container that includes the new prescription for the pharmaceutical prescribed by the healthcare provider to the patient;
dispense the labeled container to the patient; and
transmit a confirmation of the dispense.

3. The computer-implemented method as defined in claim 2, wherein preparing the label further comprises:
driving a pick head to the container situated among a plurality of said containers within a storage compartment of the drug dispensing kiosk;
picking the container from among the other said plurality of said containers with the pick head from the storage compartment within the drug dispensing kiosk; and
moving the picked container from the storage compartment to a labeling zone within the drug dispensing kiosk.

4. The computer-implemented method as defined in claim 3, wherein the plurality of said containers:
are each selected from the group consisting of a bottle, a box and a foil package; and
have different sizes and shapes and contain different pharmaceuticals.

5. The computer-implemented method as defined in claim 3, wherein the dispense order is initiated by a human agent, whereby the dispensing of the labeled container to the patient from the drug dispensing kiosk is a subjective dispensing decision to dispense the new prescription for the pharmaceutical prescribed by the healthcare provider to the patient.

6. The computer-implemented method as defined in claim 1, wherein the communicating of the input from the patient to the drug dispensing kiosk further comprises receiving payment from the patient for the new prescription for the pharmaceutical prescribed by the healthcare provider to the patient.

7. The computer-implemented method as defined in claim 2, further comprising, in response to the transmission of the confirmation of the dispense, performing a step sufficient to invalidate any further said requests to fill the new prescription for the pharmaceutical prescribed by the healthcare provider to the patient.

8. A non-transient computer readable medium comprising software executed by hardware to perform the computer-implemented method as defined in claim 1.

9. A non-transitory computer-readable storage medium on which is encoded executable program code, the program code comprising:
program code for communicating a new prescription order:
from a web-enabled mobile computing device at a first location;
to fill a new prescription;
for a pharmaceutical prescribed by a healthcare provider to a patient, wherein:
the communicated new prescription includes an image captured by an image capture device of the web-enabled mobile computing device; and
the captured image is that of the new prescription for the pharmaceutical prescribed by the healthcare provider to the patient;
program code for communicating video teleconferencing traffic between a pharmacist at a second location and the patient at a third location selected from the group consisting of:
a location of the web-enabled mobile computing device used to place the electronic order for the new prescription;
a location of a drug dispensing kiosk; and
a combination of the foregoing;
program code for communicating input from the patient to the drug dispensing kiosk when the patient is co-located with the drug dispensing kiosk;
program code for communicating, in response to the input from the patient when co-located with the drug dispensing kiosk, input from the drug dispensing kiosk to the pharmacist at the second location; and
program code for communicating a dispense order to dispense, in response to input from the pharmacist, the new prescription to the patient from the drug dispensing kiosk.

10. The non-transitory computer-readable storage medium as defined in claim 9, wherein the dispense order includes instructions for the drug dispensing kiosk to:
prepare a label bearing patient-specific information from the new prescription for the pharmaceutical prescribed by the healthcare provider to the patient;
apply the label to a container that includes the new prescription for the pharmaceutical prescribed by the healthcare provider to the patient;
dispense the labeled container to the patient; and
transmit a confirmation of the dispense.

11. The non-transitory computer-readable storage medium as defined in claim 10, wherein preparing the label further comprises:
driving a pick head to the container situated among a plurality of said containers within a storage compartment of the drug dispensing kiosk;
picking the container from among the other said plurality of said containers with the pick head from the storage compartment within the drug dispensing kiosk; and
moving the picked container from the storage compartment to a labeling zone within the drug dispensing kiosk.

12. The non-transitory computer-readable storage medium as defined in claim 11, wherein the plurality of said containers:
are each selected from the group consisting of a bottle, a box and a foil package; and
have different sizes and shapes and contain different pharmaceuticals.

13. The non-transitory computer-readable storage medium as defined in claim 11, wherein the dispense order is initiated by a human agent, whereby the dispensing of the labeled container to the patient from the drug dispensing kiosk is a subjective dispensing decision to dispense the new prescription for the pharmaceutical prescribed by the healthcare provider to the patient.

14. The non-transitory computer-readable storage medium as defined in claim 9, wherein the communicating of the input from the patient to the drug dispensing kiosk further comprises receiving payment from the patient for the new prescription for the pharmaceutical prescribed by the healthcare provider to the patient.

15. The non-transitory computer-readable storage medium as defined in claim 9, wherein the program code further comprises program code, in response to the transmission of the confirmation of the dispense, for invaliding another said request to fill the new prescription for the pharmaceutical prescribed by the healthcare provider to the patient.

16. A non-transitory computer-readable storage medium on which is encoded executable program code, the program code comprising:
program code for communicating from a web-enabled mobile computing device:
a request to fill a new prescription for a pharmaceutical prescribed by a healthcare provider to a patient; and
an identifier for one of a plurality of drug dispensing kiosks from which the new prescription is to be dispensed, wherein:
the communicated new prescription includes an image captured by an image capture device of the web-enabled mobile computing device; and
the captured image is that of the new prescription for the pharmaceutical prescribed by the healthcare provider to the patient;
program code for facilitating video teleconferencing between the web-enabled mobile computing device and a pharmacist computing system;
program code for receiving data input by the patient to the identified said drug dispensing kiosk;
program code for communicating the data input by the patient to the identified said drug dispensing kiosk to the pharmacist computing system; and
program code for communicating to the identified said drug dispensing kiosk a dispense order, in response to input from the pharmacist computing system, to dispense the new prescription for the pharmaceutical prescribed by the healthcare provider to the patient.

17. The non-transitory computer-readable storage medium as defined in claim 16, wherein the dispense order includes instructions for the identified said drug dispensing kiosk to:
prepare a label bearing patient-specific information from the new prescription for the pharmaceutical prescribed by the healthcare provider to the patient;
apply the label to a container that includes the new prescription for the pharmaceutical prescribed by the healthcare provider to the patient;
dispense the labeled container to the patient; and
transmit a confirmation of the dispense.

18. The non-transitory computer-readable storage medium as defined in claim 16, wherein the dispense order is initiated by a human agent, whereby the dispensing of the labeled container to the patient from the drug dispensing kiosk is a subjective dispensing decision to dispense the new prescription for the pharmaceutical prescribed by the healthcare provider to the patient.

19. The non-transitory computer-readable storage medium as defined in claim 16, wherein the communicating of the input from the patient to the drug dispensing kiosk further comprises receiving payment from the patient for the new prescription for the pharmaceutical prescribed by the healthcare provider to the patient.

20. The non-transitory computer-readable storage medium as defined in claim 16, wherein the program code further comprises program code, in response to the transmission of the confirmation of the dispense, for invaliding another said request to fill the new prescription for the pharmaceutical prescribed by the healthcare provider to the patient.
